(19) United States
(12) Patent Application Publication
(10) Pub. No.: US 2017/0098288 A1
(43) Pub. Date: Apr. 6, 2017

(54) AUTOMATED PERSONALIZED CONCIERGE SERVICES AND ITINERARY CREATION MATCHED TO CLIENT PROFILE FOR CHOSEN DESTINATION

(71) Applicants: NIKI SMYRNI, CHALANDRI (GR); EVGENIA SMIRNI, WILLIAMSBURG, VA (US)

(72) Inventors: NIKI SMYRNI, CHALANDRI (GR); EVGENIA SMIRNI, WILLIAMSBURG, VA (US)

(21) Appl. No.: 15/380,614

(22) Filed: Dec. 15, 2016

(51) Int. Cl. G06Q 50/14; G06Q 30/06

(52) U.S. Cl. CPC G06Q 50/14; G06Q 30/0631; G06Q 30/0641

(57) ABSTRACT

Techniques are disclosed for providing an automated personalized concierge service platform (“Travelgems”) that is global and provides instant recommendations to travelers based on actual and trusted experiences by third parties. In embodiments of the invention, Travelgems is implemented as a web-based solution and involves identifying a destination selection by a client and generating and displaying a travel guide for the identified destination in response to client entries to a first questionnaire. In a subsequent stage, a request from a client is identified for the system to generate a gem pack for the destination selection. The system generates and displays the gem pack in response to client entries to a second questionnaire. In accordance with an embodiment, the gem pack is comprised of recommendations for each of multiple categories of places and activities. These recommendations are derived from applying appropriate search algorithms that assign appropriate weights to places and activities as a function of client entries in the first and second questionnaire. In one scenario, destinations are also recommended to clients.

### FIELD

The present disclosure relates to techniques for providing web-based concierge services, and more particularly, concierge services based on client profile information.

### BACKGROUND

There is an ever increasing boom in the travel industry and this growth will only increase manifold in years to come. Even in today's busy life, people make time to travel, not just because they need a break but also to explore what's new and unseen.

There's been huge growth in online travel content. From travel blogs to trip-planning sites, the Internet is brimming with information. The marketing strategy behind many of these sites is not only to help with travel planning, but indeed many go a step further and seek to inspire customers into action. The more a visitor knows about a location, the more attractive that location becomes. With so much “compelling”, well marketed information out there, the decision of where to go and what to do is often made for the visitor and it is often is not what the visitor wants or would have chosen if he or she had more customized information.

For more personalized advice, many visitors will seek out travel recommendations from travel agents. Travel agents however work on very tight commissions and can neither afford, nor have the experience to make personalized travel recommendations for customers. Some travel agents specialize on a particular set of travel destinations with which they are personally familiar and do a decent job of recommending places to stay and things to do. But even in this case, the decision is biased either because the travel agent will not risk promoting a place or activity to a customer they may know little about themselves and end up with an unhappy customer, or because the travel agent has vested interests in promoting some packages over others. And in any case, it is very difficult for a non-local travel agent to know and be able to match a customer's (or a customer's family) interests to all possible places to visit and activities to enjoy at a given travel destination.

Also, even when a travel agent does make good recommendations, the problem is that when customers do research to learn about the recommended travel destination, the internet is designed inherently to promote the most popular destinations, as opposed to the “best” destinations, or the optimum destinations customized or tailored to the traveler.

Some sophisticated travelers rely on sites like TripAdvisor, Travello, Pepo and many like social media type sites. These sites assist travelers to make decisions by sharing comments of travelers that have experienced a certain activity or hotel stay, for example. The same information is useful to travel agents as well, to some extent, when working with clients to plan a vacation.

The problem with such sites is that many travel destinations offer some unique personalized experiences that might be extremely interesting to one person and entirely boring to someone else. A specific location in a given destination may, for example, provide one of the best views of a certain star cluster at a certain time of the year that might be interesting to a very select few people, and known only to locals. Travel agents are unlikely to know about such locations or learn about them from sites like TripAdvisor. Also, travel agents are more inclined to help customers make destination decisions and are not trained or equipped to be able to customize an itinerary of what to do once the destination decision has been made, except as we have explained to recommend the most popular activities, either because they have done experienced them personally or because sites like TripAdvisor recommend them. As for the latter, there is often false, inaccurate or misleading information posted by interested promoters, it is impossible for visitors to the site to distinguish between legitimate and illegitimate postings. Furthermore, the sheer size and volume of postings (some are in the thousands) are too large to be of any real value to prospective travelers or the travel agents working with them.

An alternate solution for sophisticated travelers is to use so called private concierge services. An experienced concierge will typically spend the time with a client to get to know the client on a more personal level so as to identify more suitable travel experiences. Unfortunately, most concierge services are only as good as the concierge, in terms of experience, age, ability to give unbiased, true feedback. High end (“luxury”) concierge services address some of these problems.

Luxury concierge services try to be all things to all people which, without a global database to work with, means that the information is limited to the experience level of the person assisting the traveler, which is not only limited, but also may not be up to date, or both. Also, as the word “luxury” suggests, such services are often best when tailored to travelers with high budgets and can afford the personalized costs associated with high end concierge services. Another problem is, by and large, they tend not to take advantage of technology to build profile-based concierge services to account for the almost infinite choices that factor into a decision. Even were a more techie approach is taken, the human element of having an actual person engaged in the process makes it impossible for travelers to have instant, 24-hour access to concierge services. As such, there is no solution that can offer both rich and poor travelers alike, but also the travel agents that work with them, a concierge type service that is automatic and a mass market approach so as to allow the costs of the service to be affordable.

There is a need for an automated personalized concierge service that provides instant recommendations to travelers based on actual and trusted experiences by third parties.

### BRIEF DESCRIPTION OF THE DRAWINGS

FIG. 1 is a web-based system for automated, personalized concierge services in accordance with an exemplary embodiment.

FIG. 2 is a high level block diagram of the Client Interface of FIG. 1.

FIGS. 3 to 56 illustrate implementation specific screen shots for generating Travel Guide and gem pack electronically displayed packages in accordance with an exemplary embodiment.

FIG. 57 is a high level operation flow chart illustrating the methodology of generating a gem pack in accordance with the exemplary embodiment.

### SUMMARY

The present disclosure is directed to systems and methods for providing an automated personalized concierge service platform (“Travelgems”) that is global and provides instant recommendations to travelers based on actual and trusted experiences by third parties.

The Travelgems system can be implemented using one or more computer apparatus. In embodiments of the invention, Travelgems is implemented as a web-based solution and involves identifying a destination selection by a client and generating and displaying a travel guide for the identified destination in response to client entries to a first questionnaire. In a subsequent stage, a request from a client is identified for the system to generate a gem pack for the destination selection. The system generates and displays the gem pack in response to client entries to a second questionnaire. In accordance with an embodiment, the gem pack is comprised of recommendations for each of multiple categories of places or activities. These recommendations are derived from applying appropriate search algorithms that assign appropriate weights to places and/or activities as a function of client entries in the first and second questionnaire.

In one aspect, the gem pack includes an itinerary for each day of travel to the destination selection for a given set of dates.

In another aspect, the gem pack includes at least one “gem”. A gem is a place or activity added by the system owner. This place or activity is added on the basis of information retrieved or obtained from trusted sources.

In another aspect, the gem pack includes a menu of the categories, whereby clicking on a category opens up a corresponding list of places and activities for that category. At least one of the categories is the itinerary. The itinerary is populated with the places and activities of the categories from which it is comprised.

In another aspect, the gem pack includes detailed information about the destination selection as well as of each place or activity that can be enjoyed at the destination.

In yet another aspect, each category includes menu selections to deselect displayed places or activities. Travelgems allows for deselecting places or activities from categories and automatically repopulating the itinerary to remove the deselected places or activities.

In a further aspect, Travelgems allows for automatically rearranging items from the itinerary in response to drag and drop selections by the client.

In yet a further aspect, Travelgems allow for automatically removing items from the itinerary and automatically replacing removed items with new places or activities from appropriate categories in the gem pack. In one scenario, the gem pack includes a menu selection of different listings for promotional places or activities associated with the destination selection.

In another scenario, a questionnaires may include a user interface provided with multiple scrolling bar selection options to enable a client to make multiple related selections about a topic from a single terminal device display screen (e.g., without scrolling). In another scenario, a progress bar is provided to show how far along in the questionnaire process the client is currently.

In yet a further scenario, clients are required to rate place/activities they participate in in order to maintain system trustworthiness and robustness.

In another aspect, the system keeps a record of deselections made by clients and/or client ratings and uses this in conjunction with a self-training algorithm that adjusts the assigned weights to places and/or activities to improve the packages generated (i.e., the Travel Guides and the gem packs).

Various objects, features, aspects and advantages of the present invention will become more apparent from the following detailed description of preferred embodiments of the invention, along with the accompanying drawings in which like numerals represent like components.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. It is to be understood that the terminology used herein is for purposes of describing particular embodiments only, and is not intended to be limiting. The defined terms are in addition to the technical and scientific meanings of the defined terms as commonly understood and accepted in the technical field of the present teachings.

As used in the specification and appended claims, the terms “a”, “an” and “the” include both singular and plural referents, unless the context clearly dictates otherwise. Thus, for example, “an apparatus” or “a device” includes one apparatus or device as well as plural apparatuses or devices.

The following description is intended to convey a thorough understanding of the embodiments described by providing a number of specific embodiments and details involving methods and systems for managing content submission and publication of content. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

The description below provides a discussion of servers, computers, and other devices that may include one or more modules. As used herein, the term “module” may be understood to refer to software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the described particular module. Further, the modules may be implemented across multiple devices and/or other components local or remote to one another. Additionally, the modules may be moved from one device and added to another device, and/or may be included in both devices. Any software implementations of the present invention may be tangibly embodied in one or more storage media, such as, for example, a memory device, a floppy disk, a compact disk (CD), a digital versatile disk (DVD), or other devices that may store computer code.

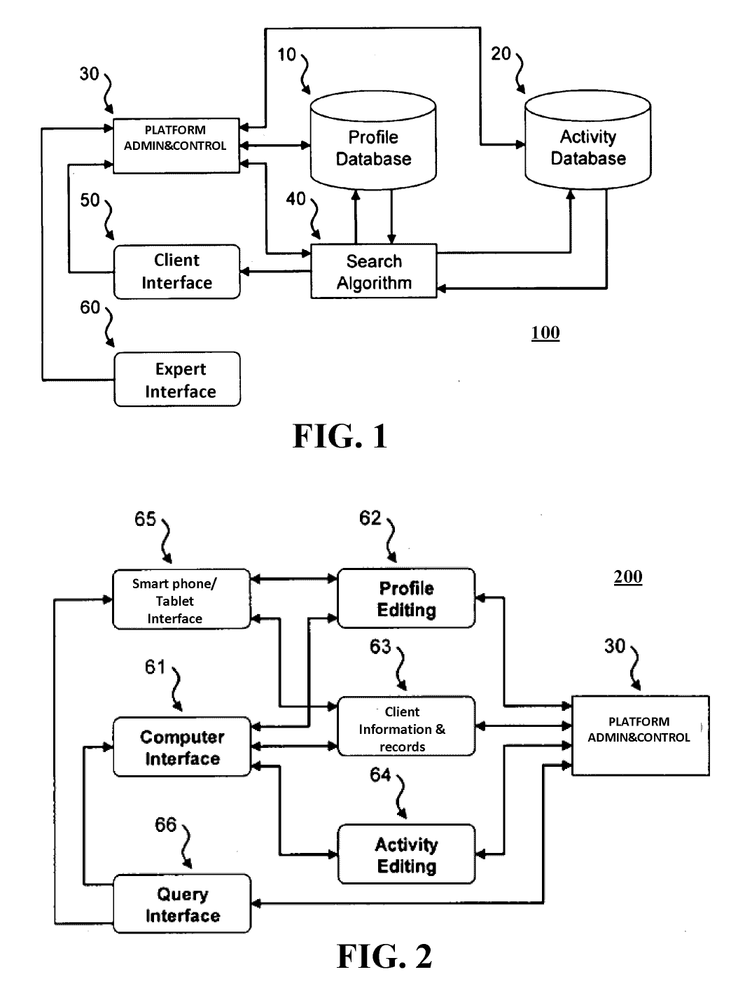

Turning now to the drawings wherein elements are identified by numbers and like elements are identified by like numbers throughout the figures as discussed below. The invention is depicted in FIG. 1 and illustrates a web-based system for automated personalized concierge system services.

The proposed web based system provides concierge services that are affordable, instantaneous (e.g., available 24 hours a day/seven days a week, online), and flexible (e.g., client can remove and replace activities in real time, on the fly, and without human involvement at any stage of the process).

Applicants have discovered that there are many reasons why concierge services remain a person-to-person activity and thus readily available either only to those that can pay the high fees associated with luxury services or to those that can afford to wait days or weeks for some service provider to review ones request and process it either entirely manually, or mostly manually. In either case, the human element, in terms of activities that are proposed plays a great factor.

Of course, the human element cannot be entirely eliminated as we are talking about providing recommendations about activities that relate to human experiences: food spots, beaches, nightly entertainment, relaxation/spa related activities, etc.

However, one reason that people gravitate to interacting with a live concierge is the need to feel assured that somehow the advice that is being given is from a trusted source.

The problem with any traditional concierge service is mainly two-fold. First, a personal concierge is hesitant to suggest activities that they themselves may not have experienced personally, and even if they had, it may have been experience way in the past. The experience may no longer be as they recall it. As such, many concierges while often asked for new and exciting and sometimes off-beat things to do, they refrain from recommending activities they are not sure about. After all, if the client is unhappy, this adversely impacts the reputation of the concierge and/or the company he/she works for. Accordingly, the human element is not very “trusted” at the end of the day, and trust ultimately comes from having a strong prior personal relationship with your concierge, or can afford a concierge that services only a particular destination, in which case, he/she may know one area very well, even the activities that off the beaten path, but not other locations. Hence, one must do significant research about different places, decide on where they want to go, and then contact a specialized concierge or travel agent that is either in the area or familiar with the area for advice on what to do.

Despite the glut of information about travel locations and recommendations to website visitors out there today—in terms of what activities one can do—the automated personalized concierge problem remains. There is currently no web-based system approach that addresses the trusted source problem and at same time provides information that is up to date, affordable, and instantaneous. There is also no approach that is able to provide an entire full-day and day-by-day web-based, printable itinerary of to-do activities populated from selectively chosen activities by the system that are tailored to the wants, needs and likes of a client, and is flexible in terms of client being able to make changes to the itinerary, and have the system propose substitute activities on the fly.

The following description of the preferred embodiment of the present invention makes reference to the included drawings which form a part hereof. Said drawings show by way of illustration a specific embodiment in which the invention may be implemented. It is not intended in any way that said illustrations limit the scope of the invention to only the embodiment described herein. The present invention is also expected to be embodied in other forms not specifically addressed in the illustrations that form a part of this description.

The present invention provides a personalized concierge service to clients of the system illustrated in FIG. 1. For purposes of discussion, the system and methodology described shall be referred to as the “Travelgems™” system and “Travelgems” methodology, respectively.

It should be appreciated that the word “client” as used herein is meant to be used interchangeably with the following word or words including “user”, “registered user”, “subscriber”, “customer”, “traveler”, “website visitor”, and travel agent (where the user/customer is a travel agent).

The concierge service, as contemplated herein, provides destination-specific, automated itinerary information and recommendations about places to visit, activities to enjoy, services offered, special events, etc. These may be referred to collectively, for convenience, as “places”, “activities”, “places and activities”, or any suitable similar combination of words. A destination, likewise, could be one or more destinations selected by the user, or automatically, or randomly selected by the concierge service in accordance with different exemplary embodiments.

The included embodiment of the present invention is comprised of several components (as illustrated in FIG. 1), namely Client Profile Database 10, activity database 20 (hereafter “Travelgems Database”), Platform Administration & Control Module 30, Search Algorithm module 40, Client Interface module 50, and Expert Interface module 60.

Each component of the present invention is described herein below.

Travelgems Database 20 is a massive database that contains specific information about a wide variety of places, activities, services, and events (collectively, hereafter, “Travelgems”) for all cities and towns covered by the service. Such activities, services, events include (but are not limited to) restaurants, night clubs, sporting events, movies, theater, beaches, cultural activities, religious activities, etc. Information is populated into the Travelgems Database 20 by data entry personnel via Expert Interface module 60. Information is retrieved from the system by clients seeking concierge services and personalized itineraries via client interface module 50.

Client Profile Database 10 is a massive database that contains specific information about each user/subscriber of the concierge service. Such information may include (but is not limited to) the user's name, contact information, address, family situation, pet owner information, birth date, and activity preferences. Information is populated into the Client Profile Database utilizing Client Interface module 50. Data from Client Profile Database 10 is used by Search Algorithm module 40 in order to perform personalized searches of the Travelgems Database 20.

Administration System module 30 manages the entire system. All interaction between system users and the system databases is managed and controlled via Administration System module 30.

Search Algorithm module (40) is used to perform searches on Travelgems Database 20 and/or the Client Profile Database 10 depending on the feature or function requested by a given user. Search Algorithm module 40 can utilize personal information from Client Profile Database 10, information relating to the user's chosen travel destination location, and information relating to the user's chosen timeframe in order to perform a personalized search of the Travelgems Database 20.

Search Algorithm module 40 can also perform comparative searches within the Client Profile Database 10 in order to identify users with compatible profiles, identify travel habits, and other functions, and may use this information to compare and update activity related information in Travelgems Database 20. In one scenario, search module 40 facilitates match-making to schedule travelers wanting to share an entire itinerary, a partial itinerary, or just a single activity. Matching of a single activity is particularly important for activities that require a sufficient minimum interested participants.

Client Interface module 50 is used to give users/subscribers of the service access to the system. FIG. 2 illustrates one embodiment of Client Interface module 50. Client Interface module 50 can have multiple interface types.

In the embodiment illustrated in FIG. 2, a Computer Interface sub-module (61) and a Smart phone/Tablet Interface sub-module (65) are provided. Query interface sub-module 66 communicates with platform administration and control module 30 to generate the queries associated with generating Travel Guide and Gem Pack information displayed to clients/site visitors (described in detail below).

Query interface sub-module 66 forwards the queries to client computing terminals (not shown) which interface with the Travelgems system via an appropriate web-based interface. In the case of desktop, laptop or the like computing devices, the queries are received by computer interface sub-module 61 and displayed on the client display. In the case of a smart phone, tablet or like portable device, the queries are received by sub-module 65 and displayed on that corresponding client display.

In addition to receiving and making entries associated with the queries displayed, sub-modules 61 and 65 is used to register and updated client records via client information & record sub-module 63., under overall system control provided by platform admin & control module 30 system control.

Entries associated with client responses to queries result in Travelgems creating a profile for each user. The profiles and responses to queries are stored in Client Profile Database 10 and are updated by clients via profile editing sub-module 62.

The Travelgems system uses the profile information to generate two different types of electronically displayed concierge packages. The first package is a destination specific Travel Guide. The second package (hereafter “gem pack”) is a detailed personalized concierge breakdown of places and activities proposed to the client based on previously generated and stored profile information. Activity editing sub-module 64 is used to enable clients (via interface sub-modules 61 and 65) to make edits to the gem pack. Platform admin and control module 30 processes the edits from sub-module 64 to cause an updated gem pack to be created and displayed to the client.

Activity editing sub-module 64 may include a self-training algorithm (not shown) that keeps track of changes to determine patterns by clients, and uses this information to provide more robust weighting schemes which are used by the search algorithm module 40 and platform admin and control module 60 to collaboratively create a client gem pack. In one scenario, the self-training algorithm may also adjust weights assigned to activities in response to feedback from clients that have completed the activities that were recommended to them in a gem pack.

In another scenario, gem packs are provided as a free or low cost tool for travel agencies. The travel agencies can in turn offer unlimited free or severely discounted Travelgems packages (Travel Guide and/or gem packs) to their customers on condition that once activities are performed the customers agree to rate the experience. This way, by ensuring that places and activities are constantly updated with actual experience feedback from platform clients, a very robust (in terms of content) database is provided. Also, because all place and activity database content is information inputted into the database by the system owner (i.e., the Travelgems platform administrator) or is information that is provided by clients of the platform who have recently partaken in a recommended activity, a highly unbiased and content-objective concierge solution is provided in comparison to person-to-person services or electronic concierge services where the recommendations are based on personal recommendations provided in a social network type ecosystem approach, are untrustworthy, and of limited access or benefit to a mass audience.

Now, to better understand the presently proposed approach for providing automated personalized concierge services, reference will be drawn to the following figures.

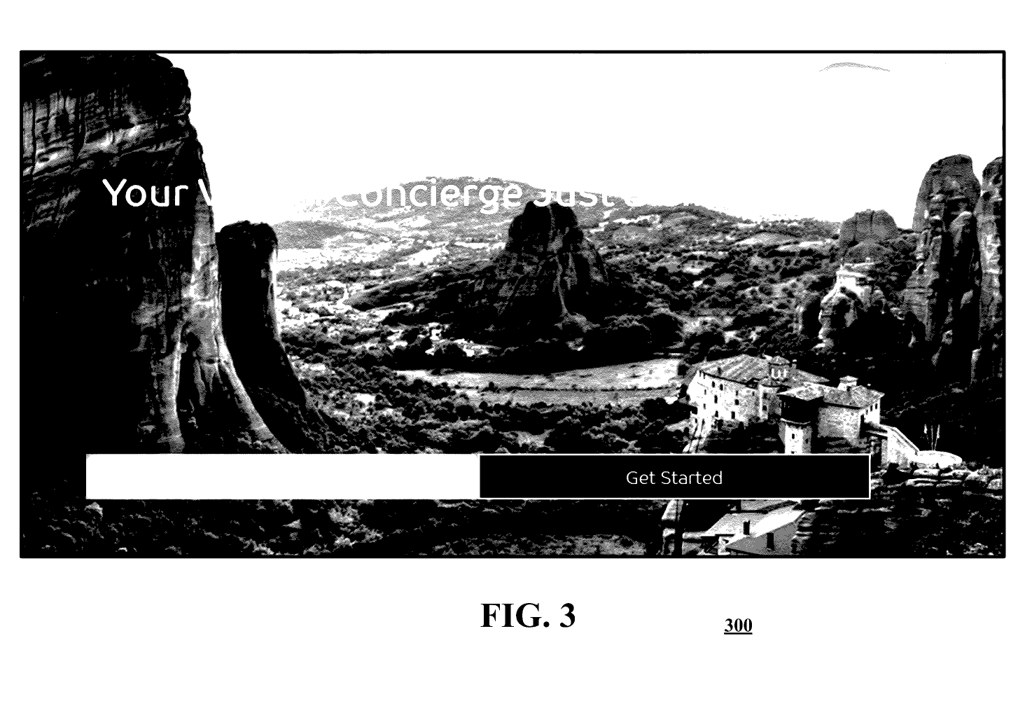

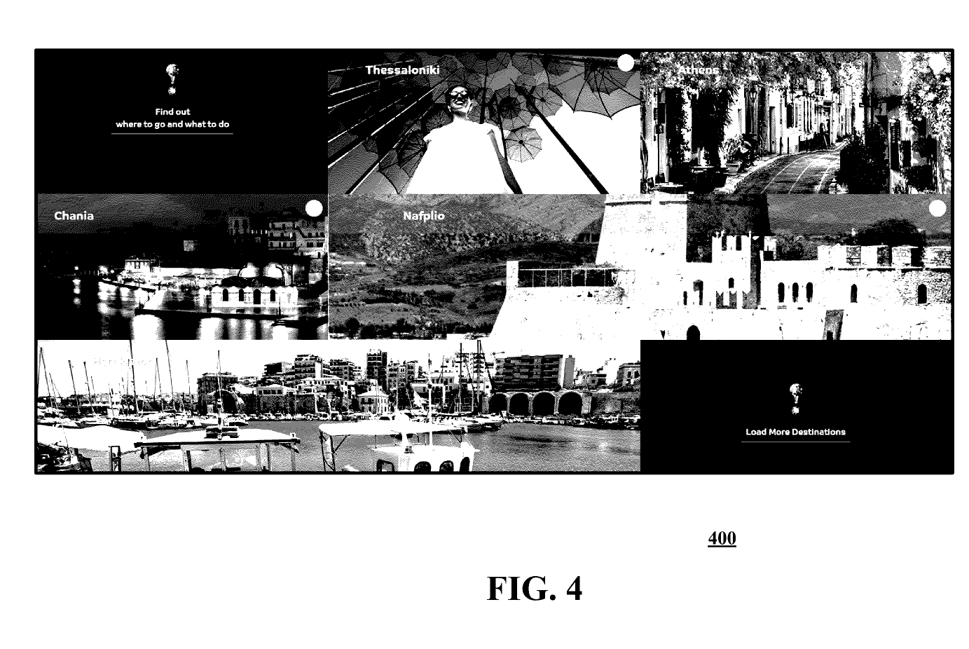

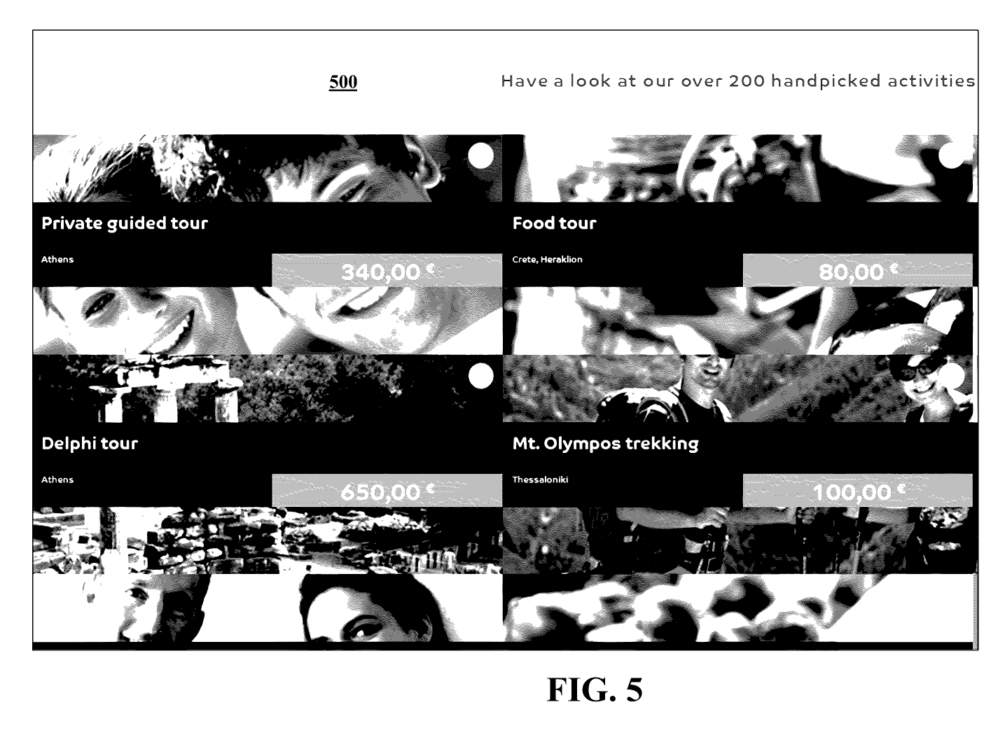

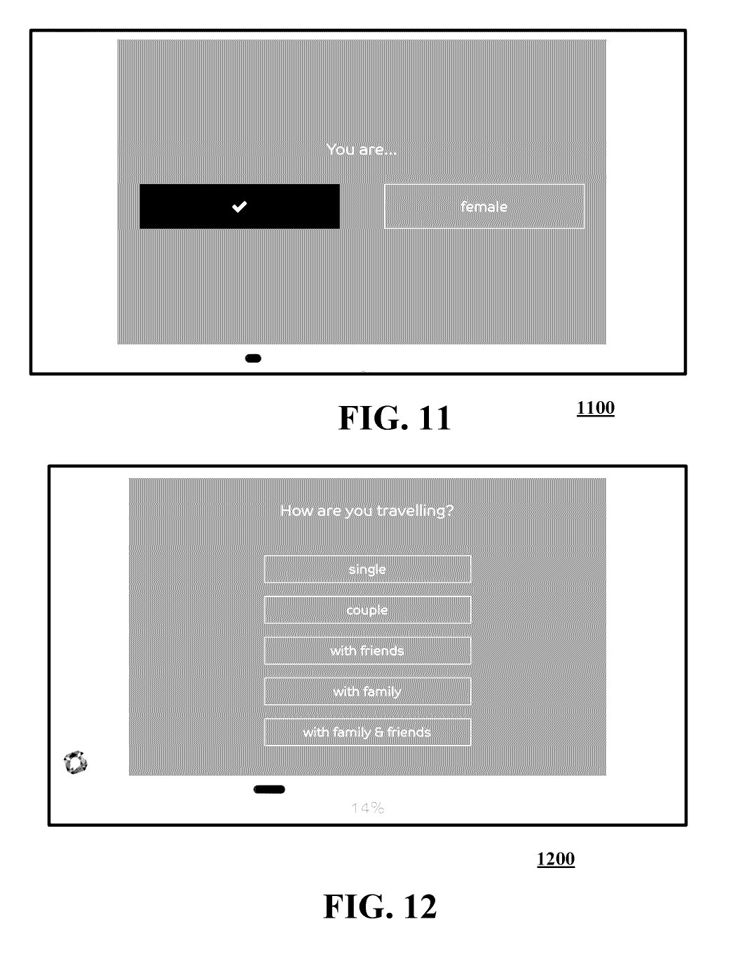

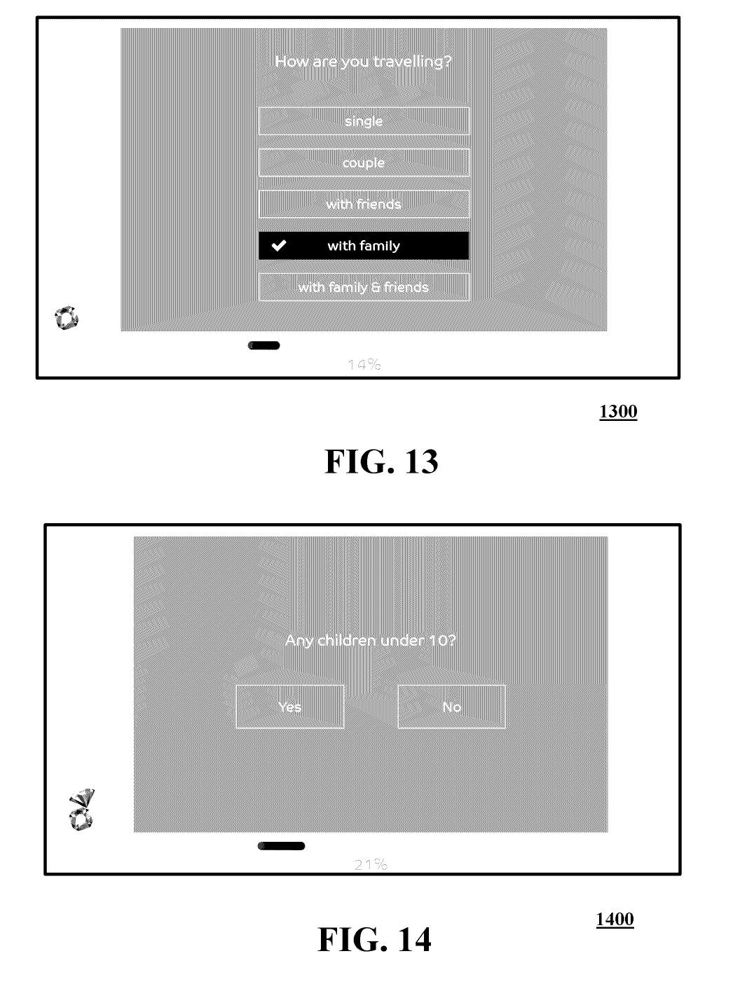

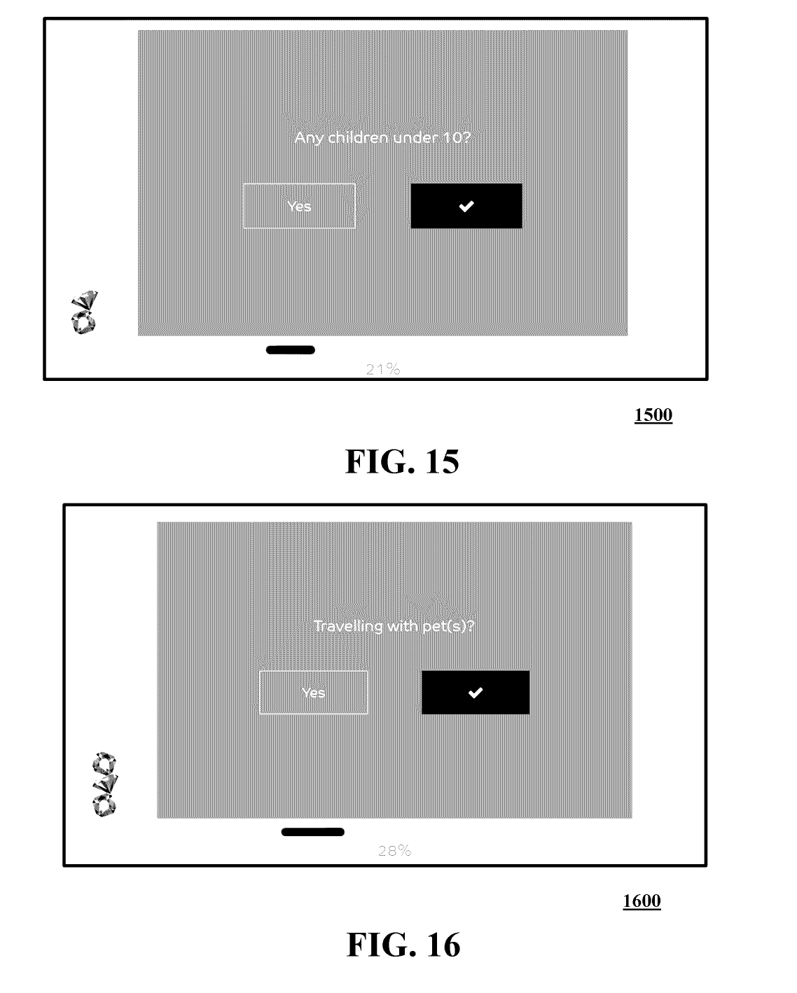

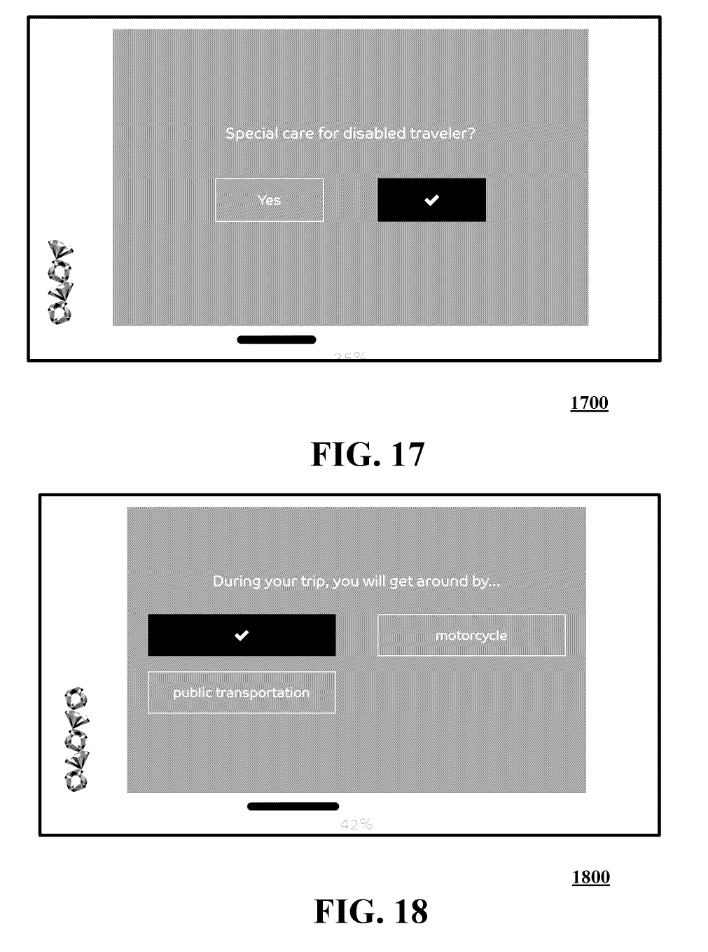

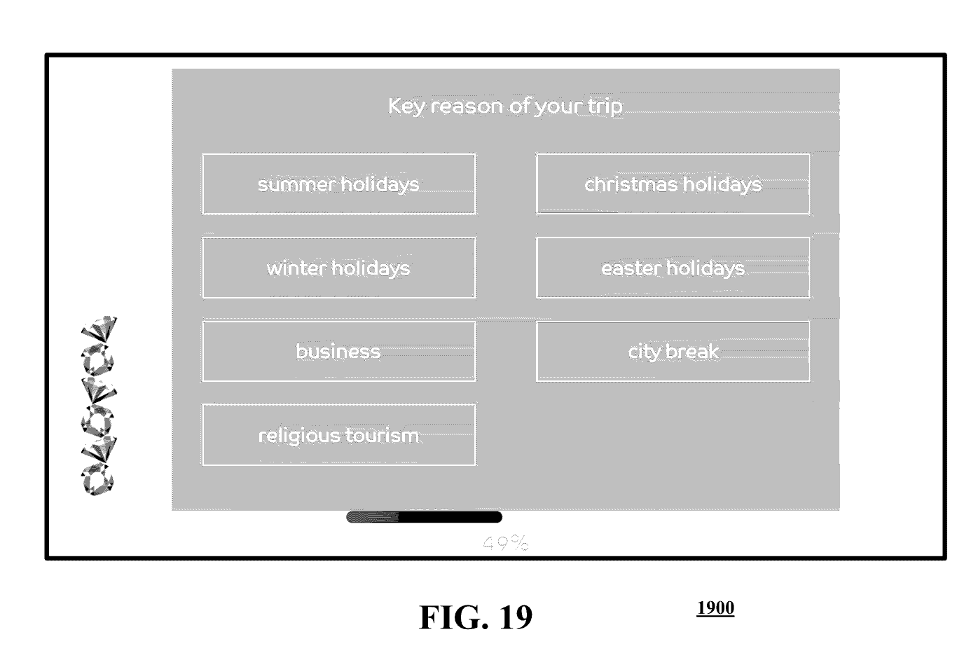

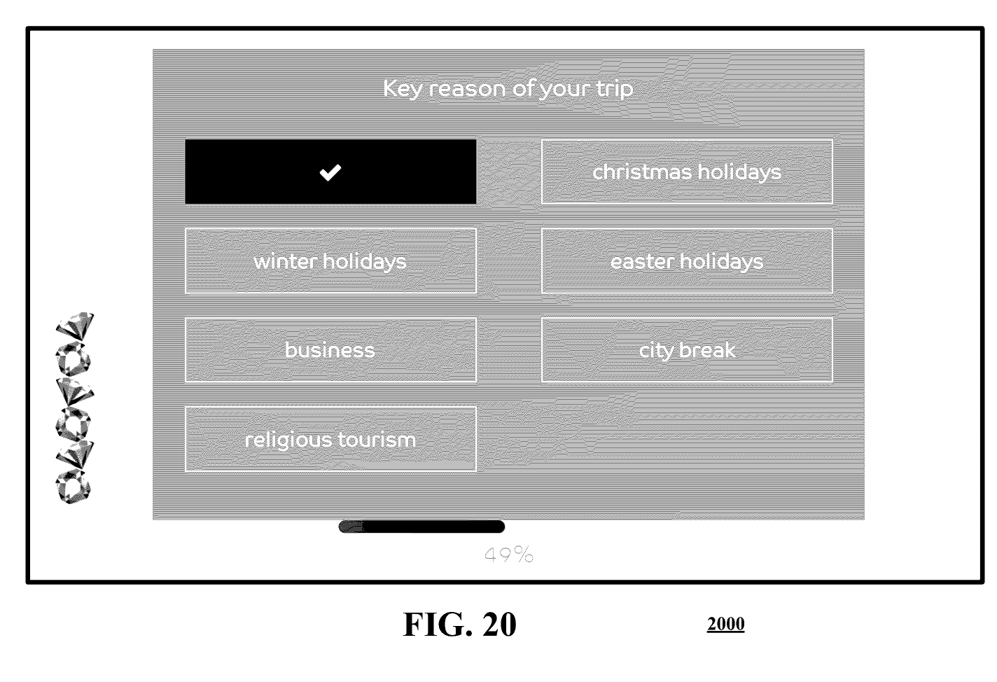

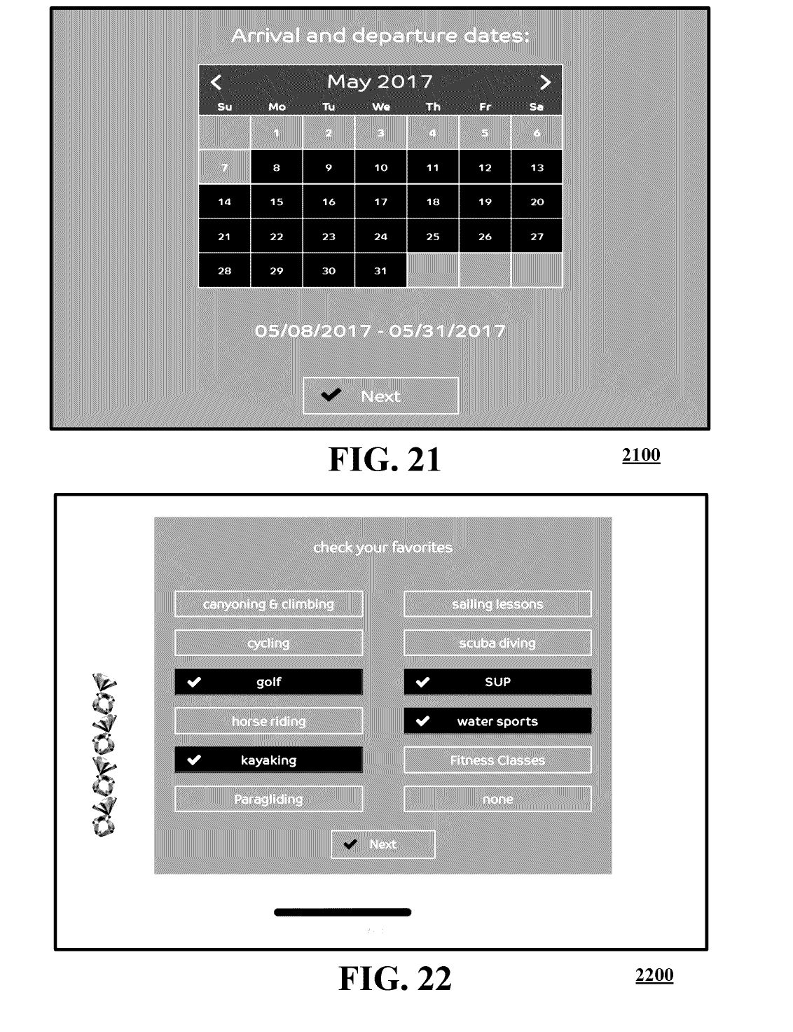

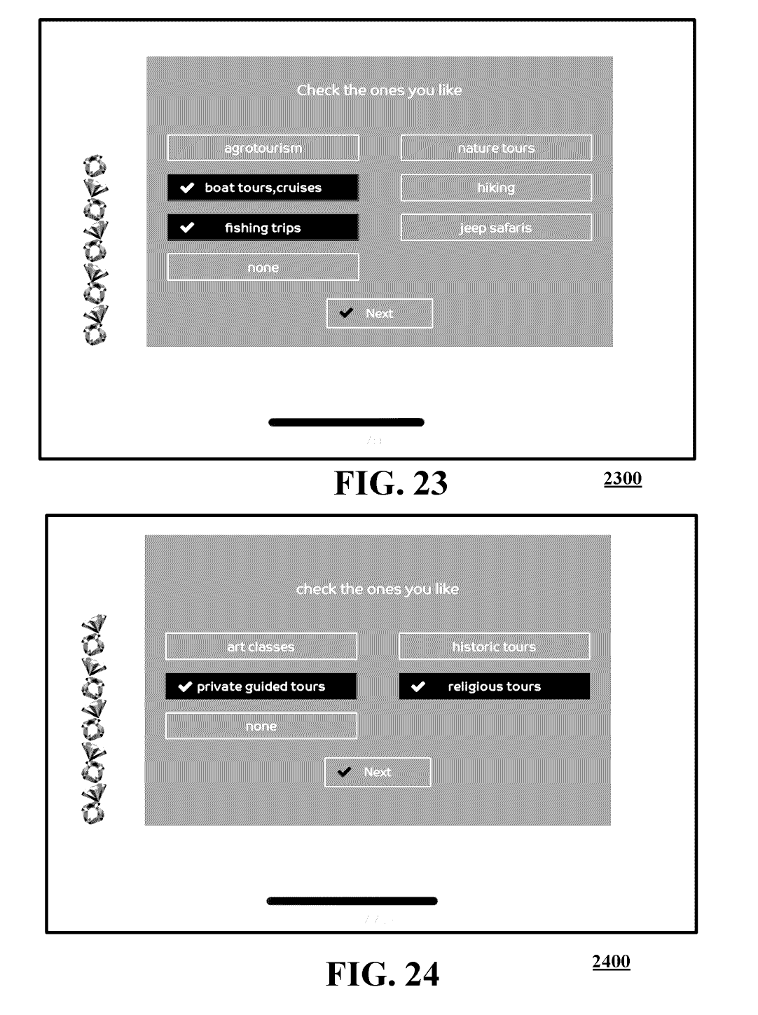

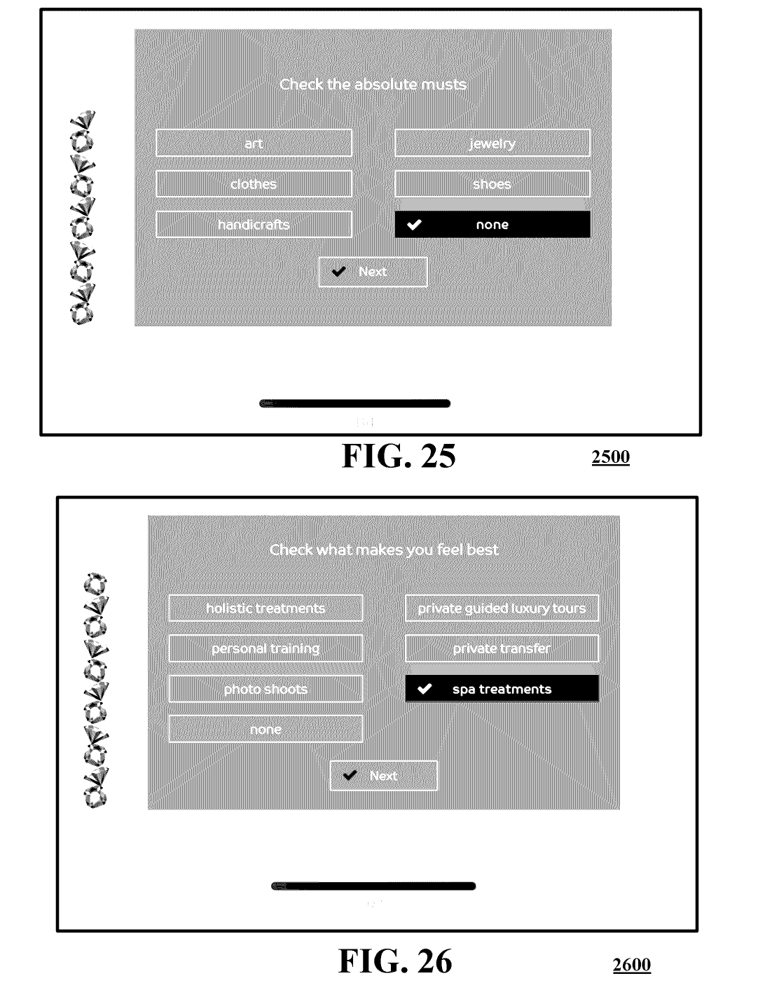

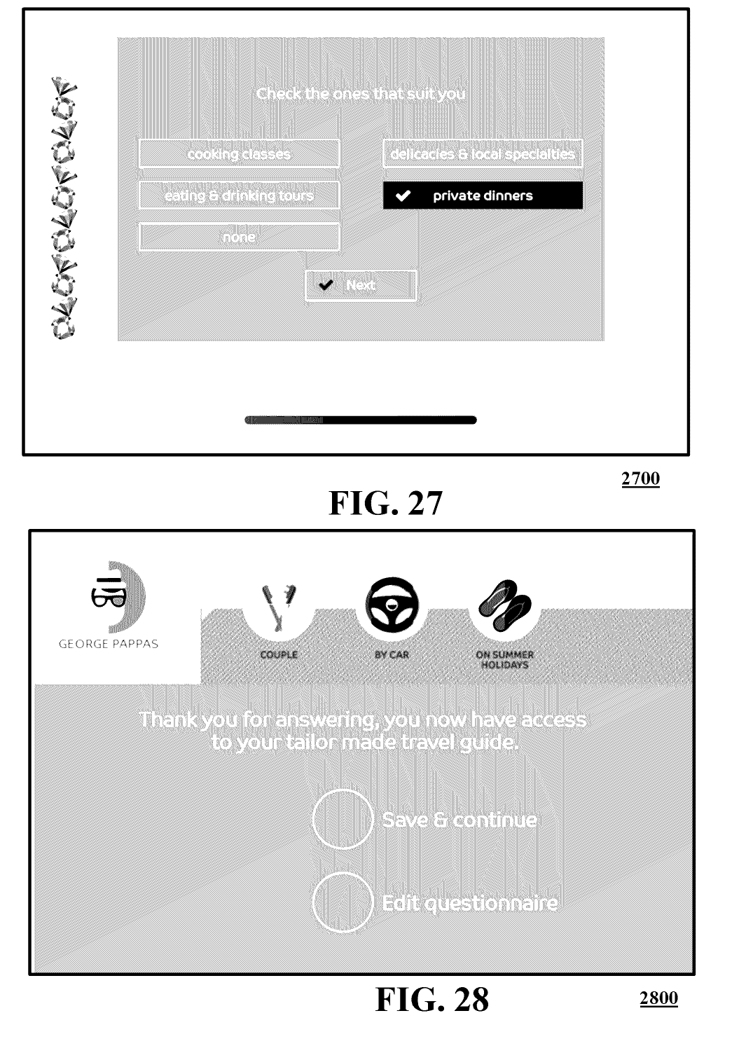

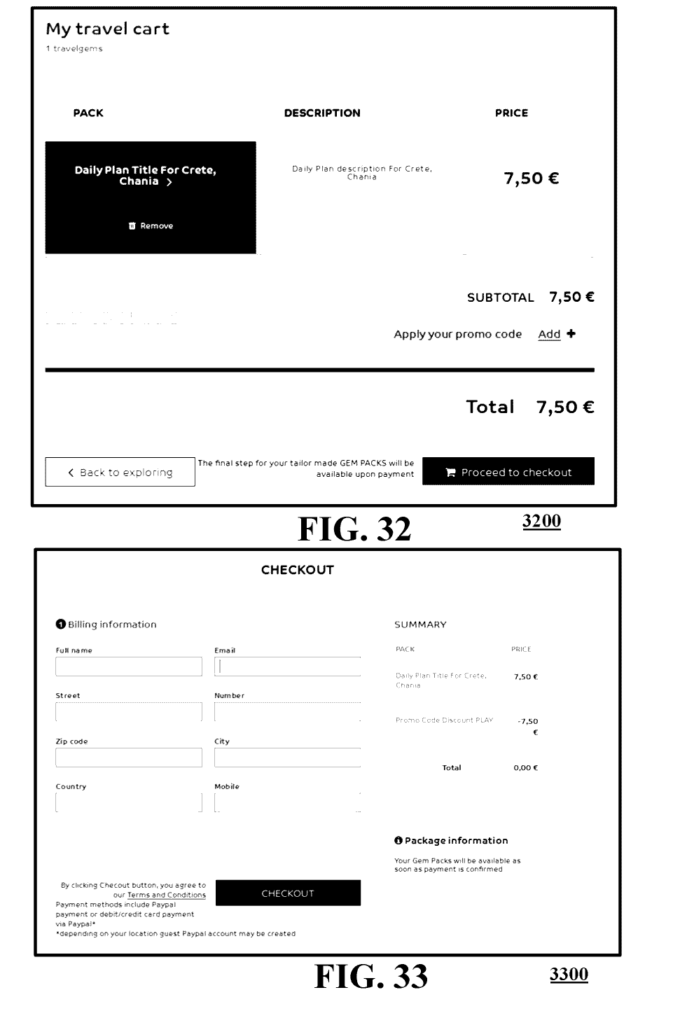

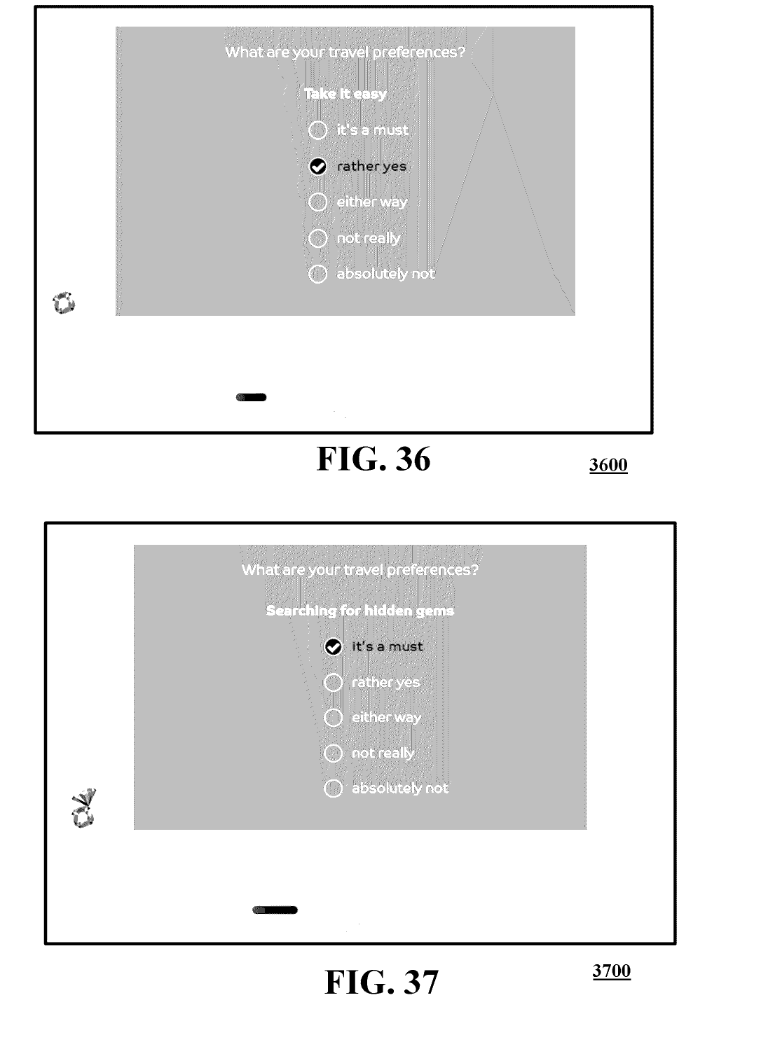

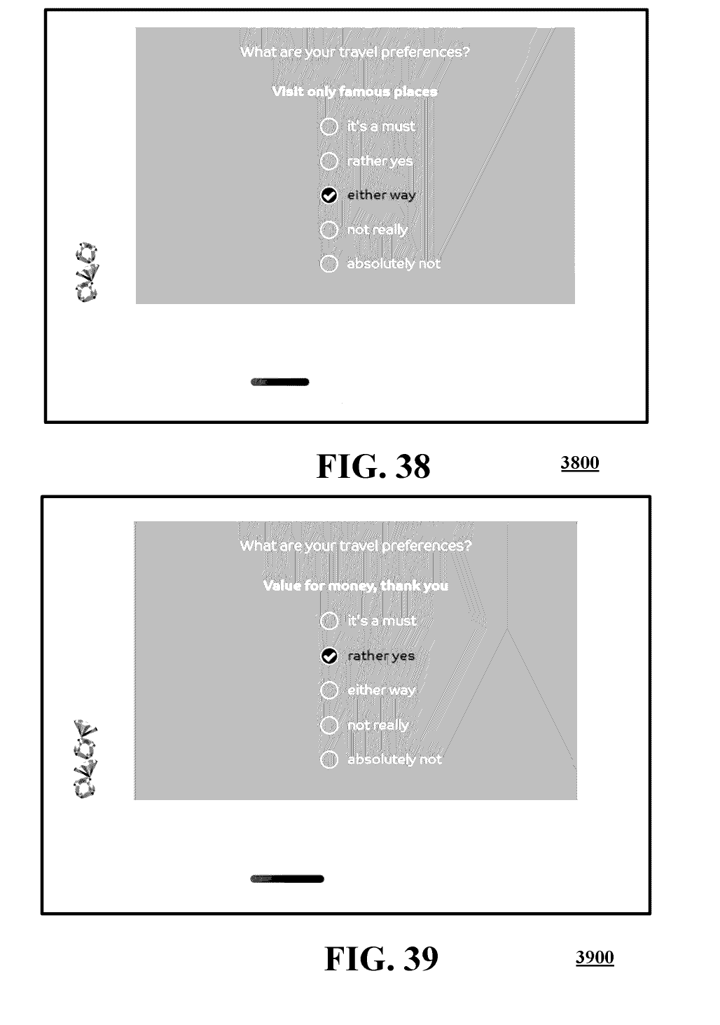

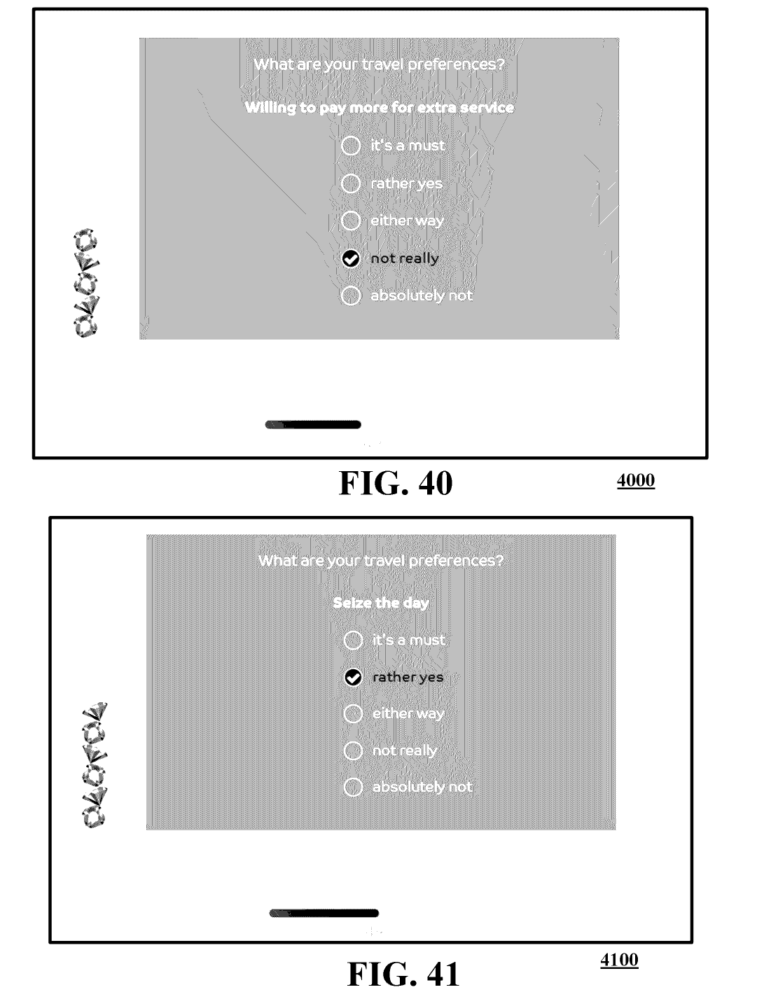

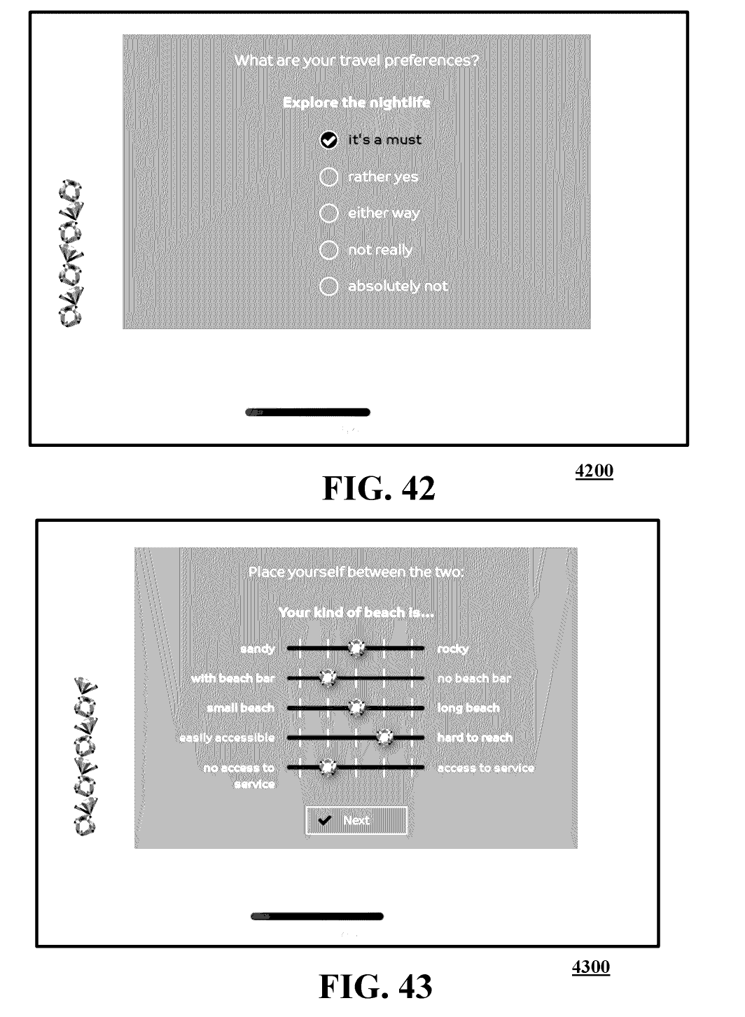

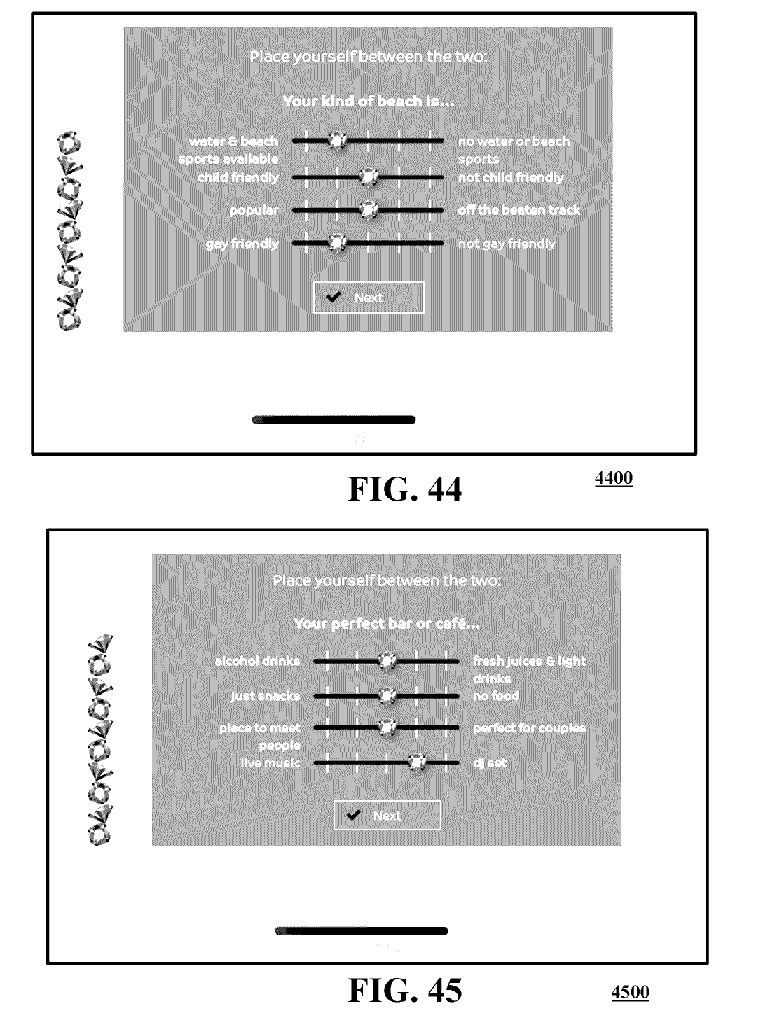

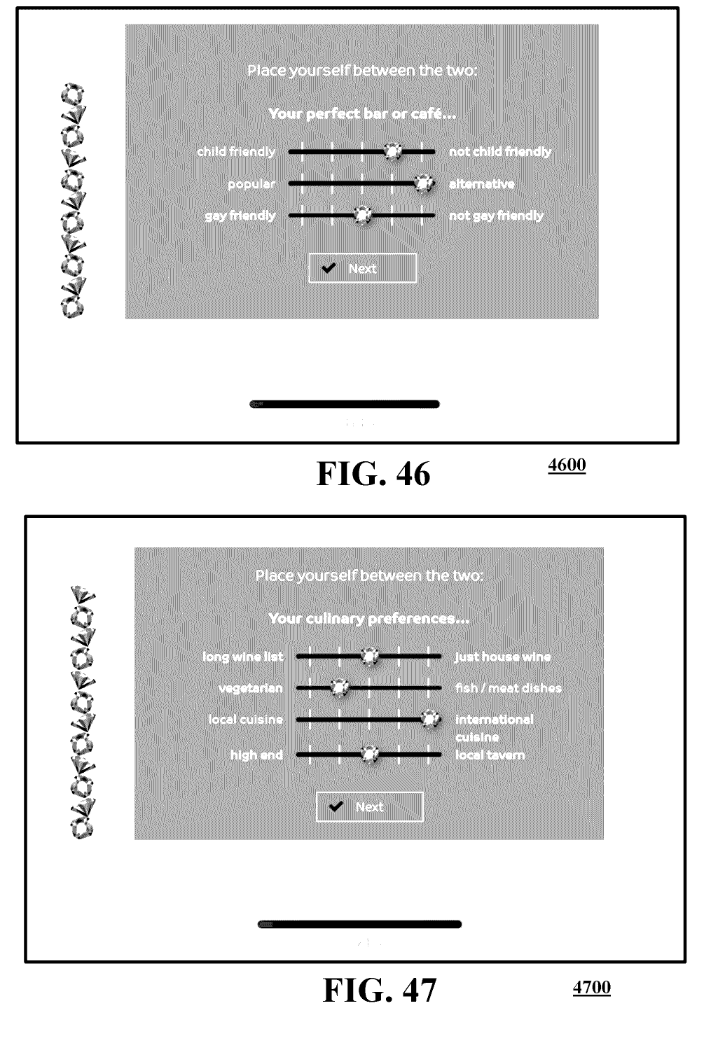

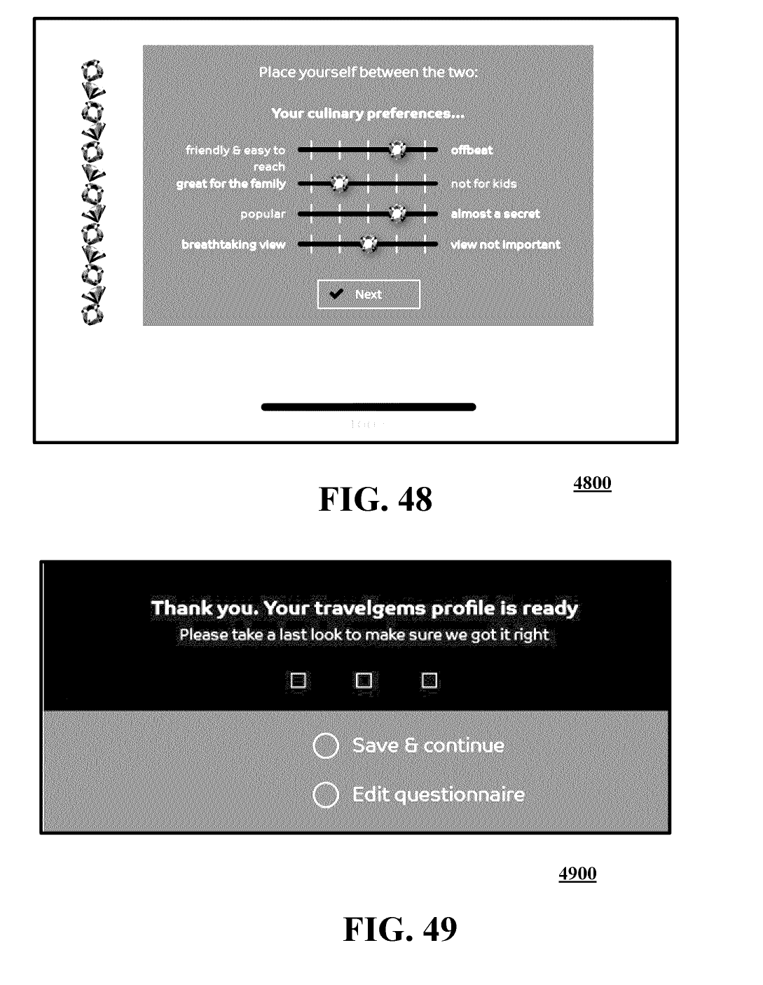

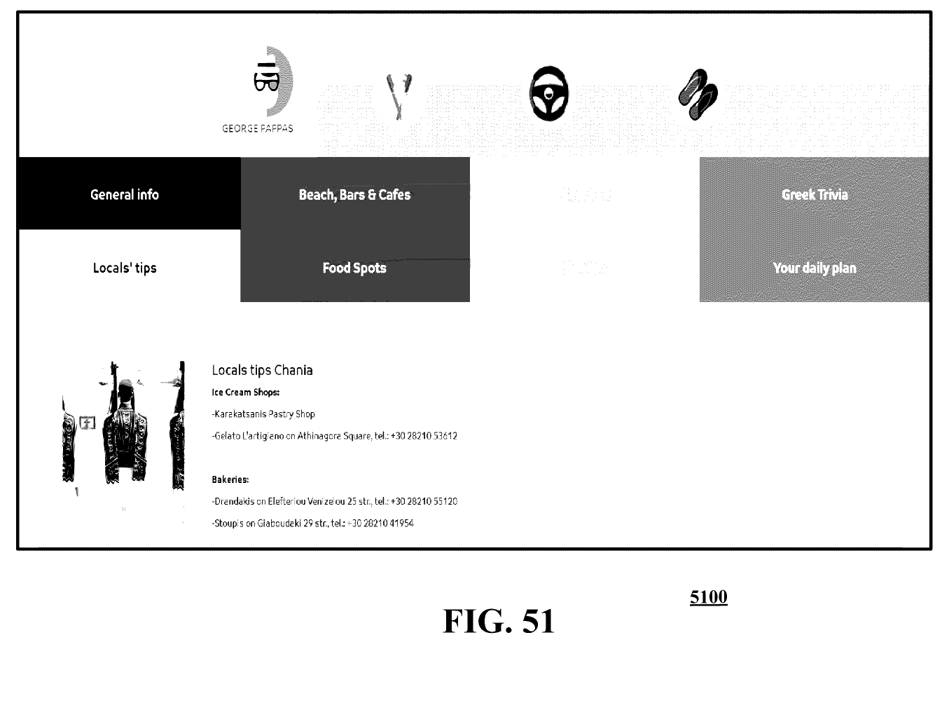

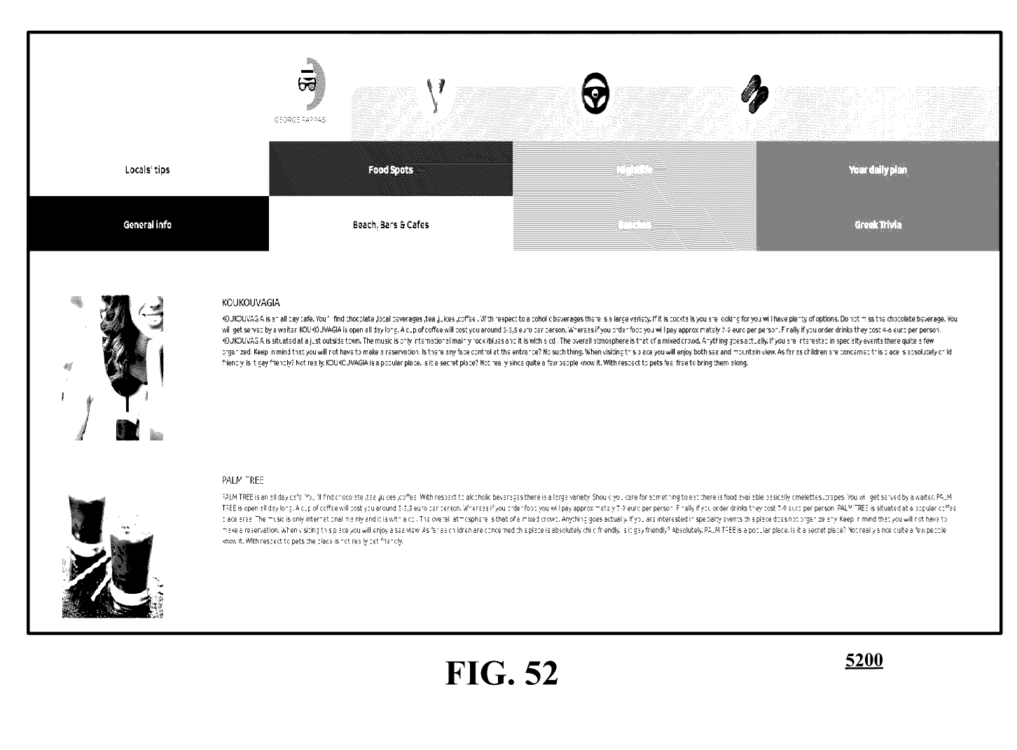

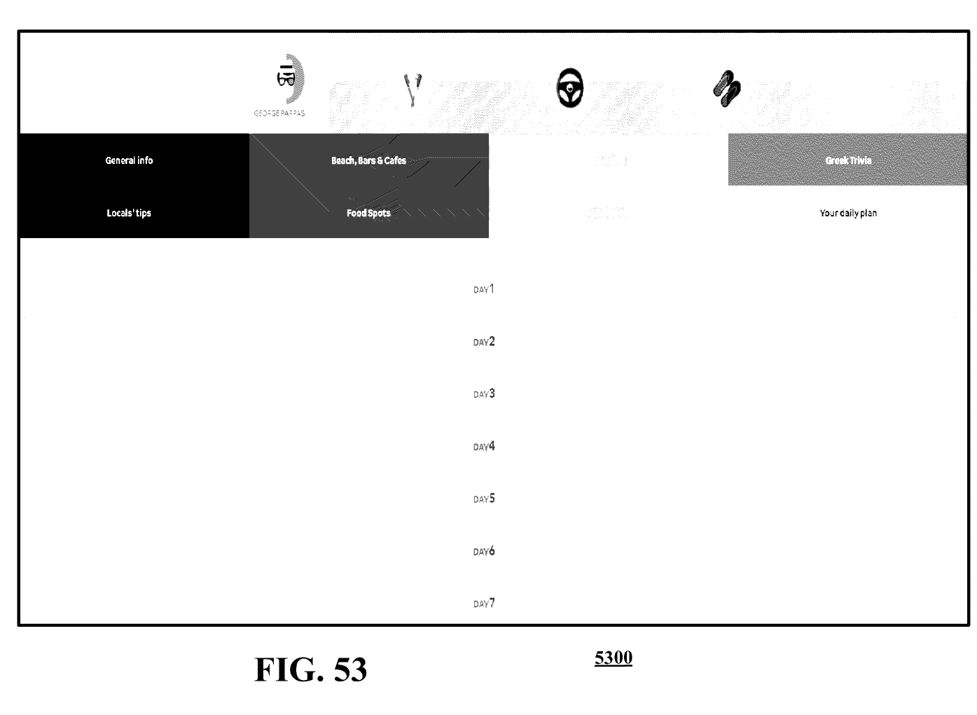

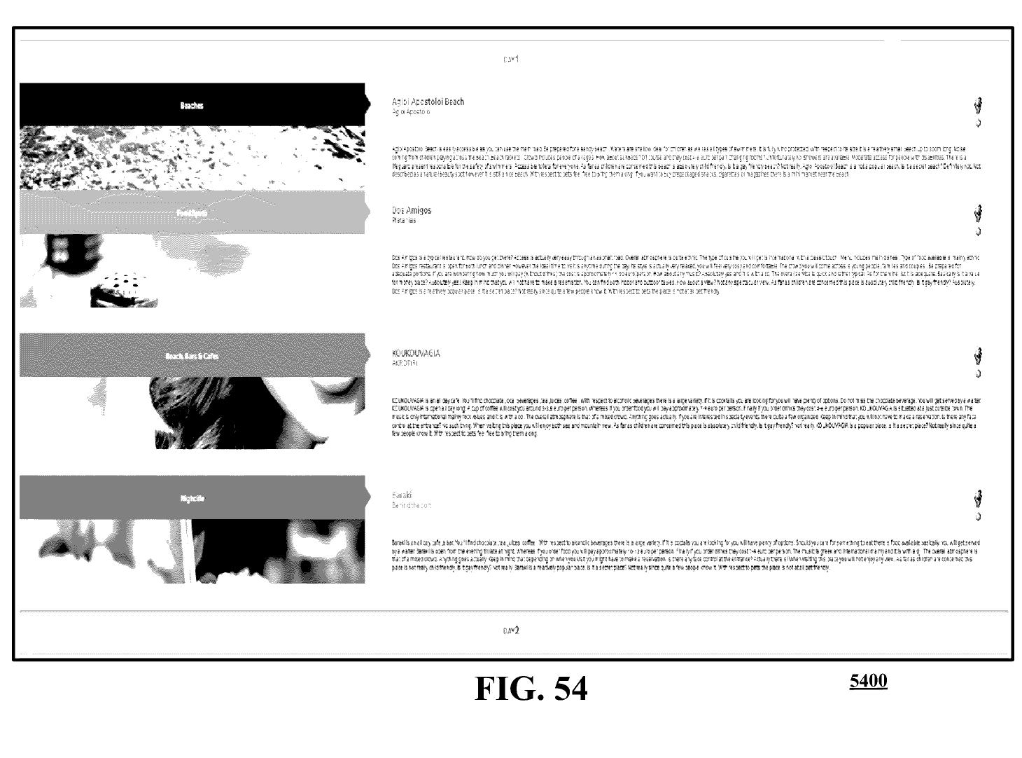

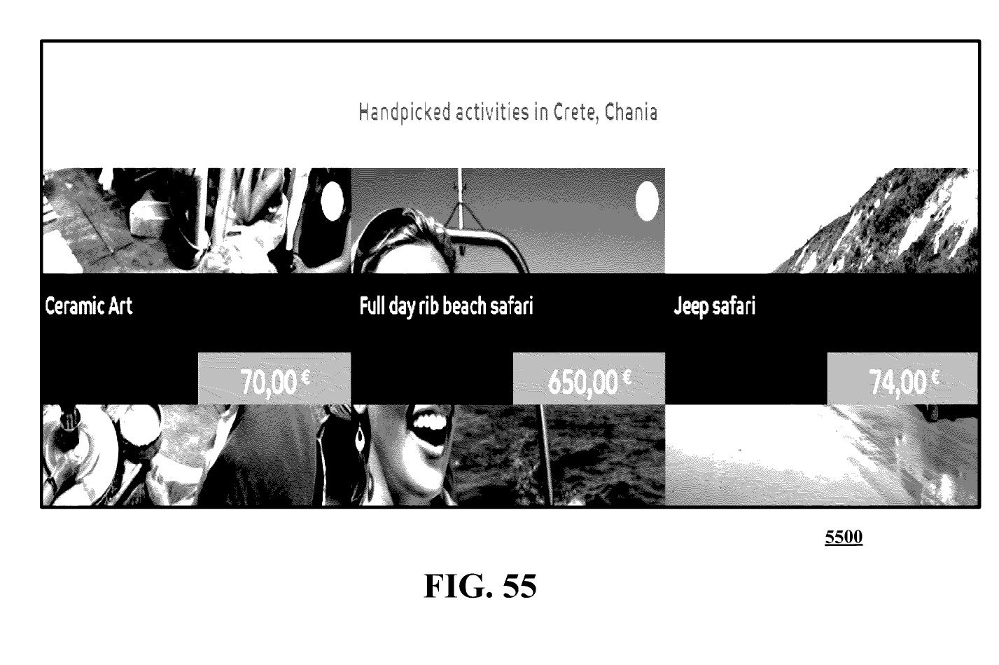

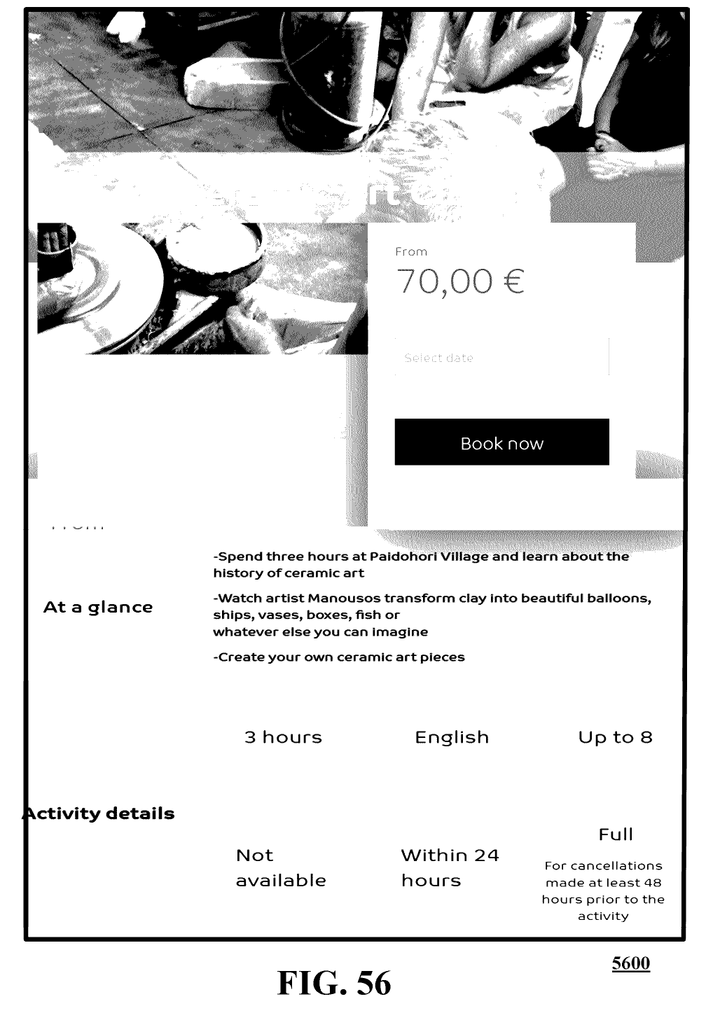

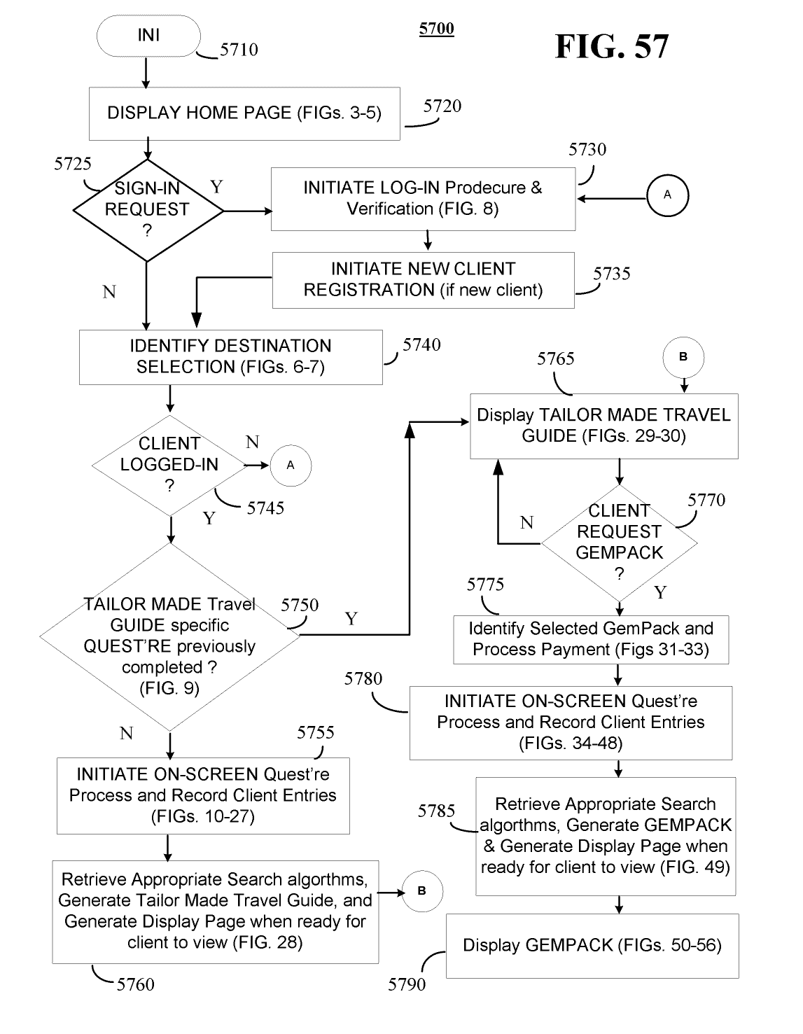

FIGS. 3 to 56 illustrate implementation specific screen shots for generating Travel Guide and gem pack electronically displayed packages in accordance with an exemplary embodiment.

FIGS. 3-5 are web-browser views of partial screenshots 300-500 created by the Travelgems system in response to a viewer clicking on or linking to a home page of the platform.

Partial home page screenshot 300 invites the site visitor to enter a destination he/she wants to receive information about. This is the first step to receiving a Travel Guide. The Travel Guide is an electronically generated information package about a destination of interest in response to queries answered by the site visitor in conjunction with a first questionnaire.

Partial home page screenshot 400 provides a menu selectable interface to help the visitor click on different destinations and learn more about them, and if he/she desires enter this destination into the destination selection field in partial screenshot 300 to obtain a more comprehensive Travel Guide.

Partial home page screenshot 500 is a menu listing of different promotional offerings available for booking. The offerings displayed may be custom tailored to the client on the basis of cookies resident on client terminal which evidence prior or recent interests or web-surfing activities. The offerings are also intended to promote unique hard to find offerings (“gems”) that are available at one or more destinations.

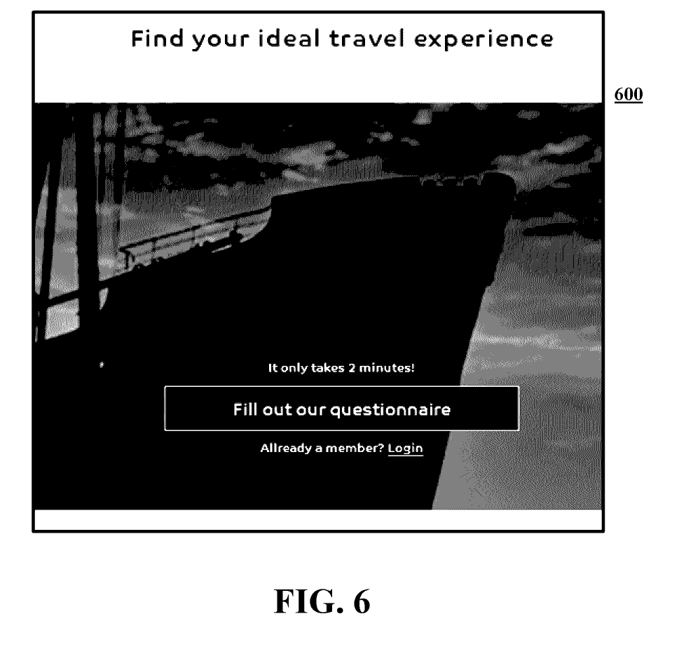

FIG. 6 is a screenshot 600 which starts the questionnaire process associated with obtaining a Travel Guide for a destination entered in screenshot 300.

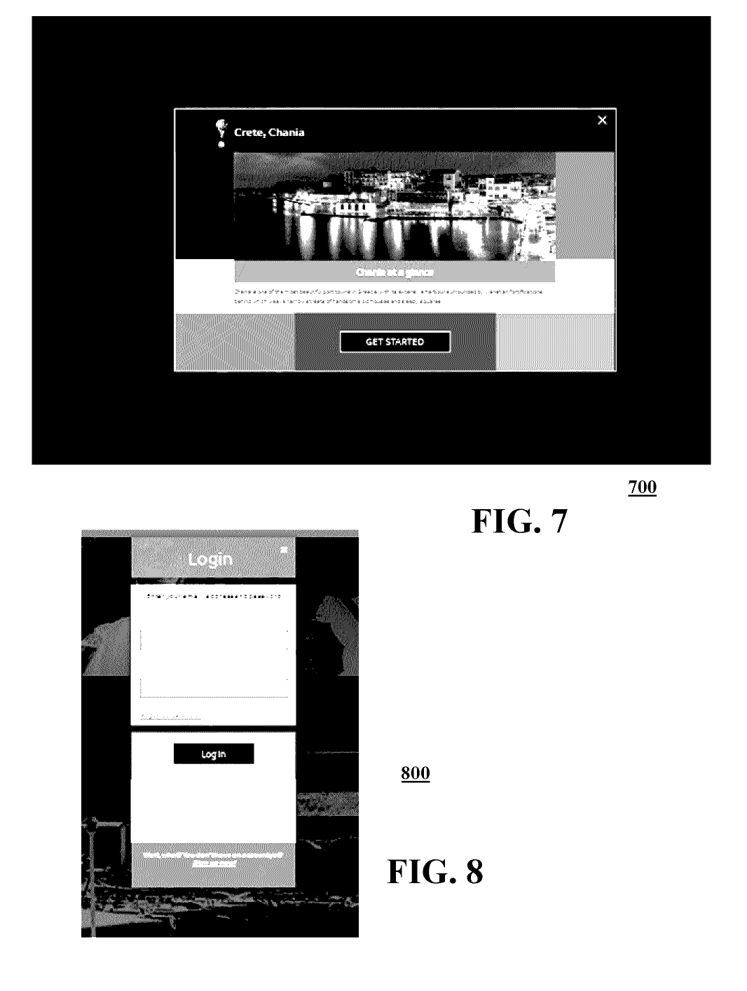

FIG. 7 is a screenshot 700 verifying the destination selection and provides a GET YOUR TRAVEL GUIDE link to initiate the process of obtaining a Travel Guide.

Referring to FIG. 8, the client will be required to log-in or register as new client. Screenshot 800 is an example log-in screen for this purpose.

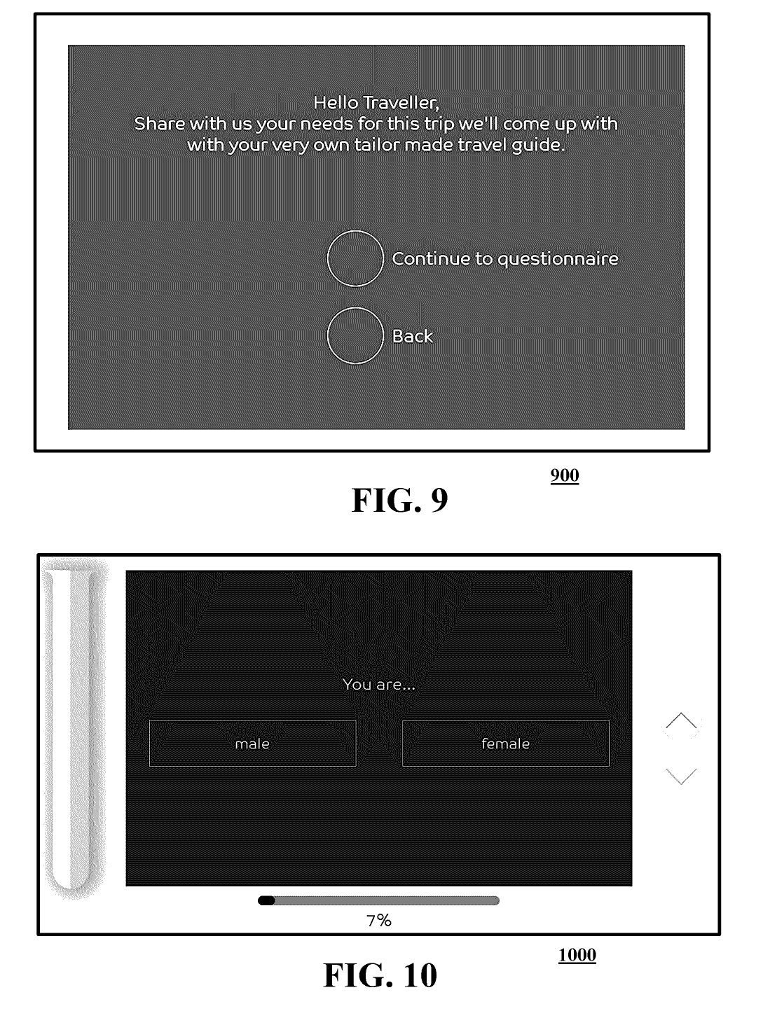

Once logged in, the client/traveler is presented with screenshot 900 (FIG. 9) where they are invited to confirm interest in obtaining a Travel Guide and that the process involves a questionnaire.

Screenshots 1000, 1100 . . . 2000 . . . 2700 (FIGS. 10-27) illustrate the questions associated with the first questionnaire which are necessary for the platform to provide a tailor made (customized) Travel Guide for the client.

Once the questionnaire is complete, the client is presented with a screenshot 2800 (FIG. 28). Here, the client is given the option to have the prepared Travel Guide displayed to them, as well as the opportunity to go back and edit the questionnaire. In the example screenshot, certain questionnaire client entries (such as, for example, that client intends to travel as a “couple”, “by car”, and will be “On Summer Holidays”) may be simultaneously presented by different icons.

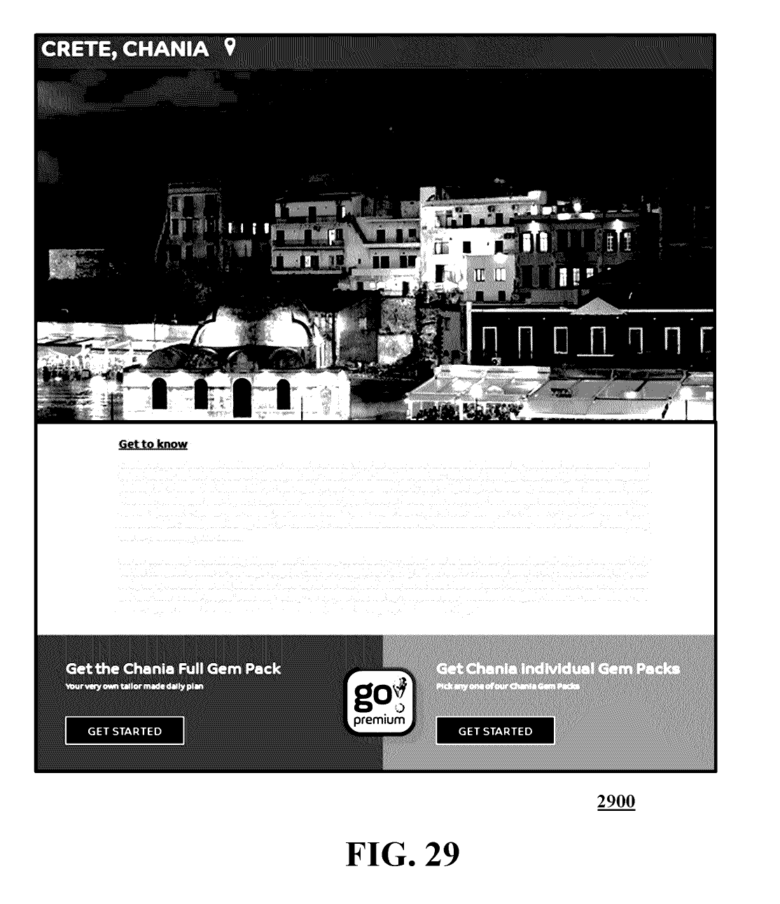

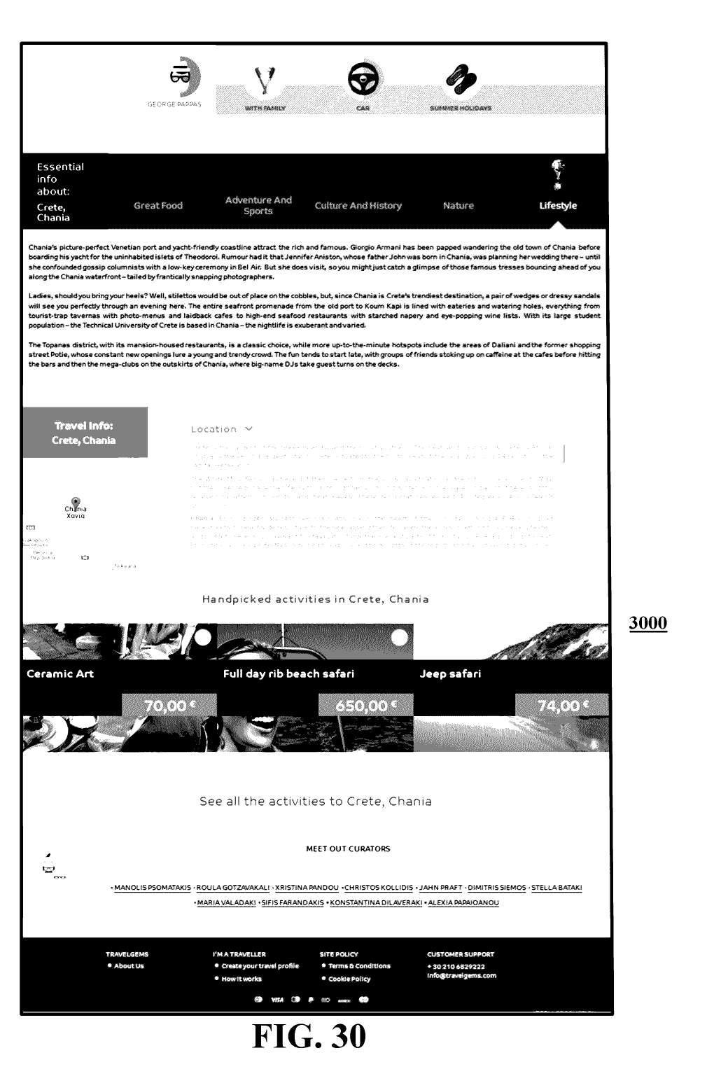

FIGS. 29 and 30 are web-browser views of partial screenshots 2900, 3000 of a newly created Travelgems Travel Guide in response to the client destination selection (Crete, Chania) and the answers to the queries in the first questionnaire.

Partial screenshot 2900 includes a detailed overview of the chosen destination selection followed by links inviting the client to obtain a personalized concierge service package (gem pack). In the example scenario, the gem pack package is available as a FULL GEM PACK and an INDIVIDUAL GEM PACK. The FULL GEM PACK is targeted for travelers and their families wishing to obtain a complete travel itinerary for the period of travel, while the INDIVIDUAL GEM PACK may be tailored to travelers who may simply be looking for customized activities either generally, or with respect to say a specific experience (getting recommendations of best beaches tailored to their habits and likes). In either instance, the platform makes recommendations that match the customer's unique interests and personality with respect to a given destination.

Partial screenshot 3000 includes further information associated with the Travel Guide. In the example screenshot, client is provided with a menu from which to view information about CRETE, CHANIA. The menu includes selections for the following topics: Great Food, Adventure and Sports, Culture and History, Nature, and Lifestyle. Hovering over a selection causes information to be displayed in the section just below the menu.

In the same screenshot 3000, client is provided TRAVEL INFO for the same destination. This is very much information one would expect from a travel guide. A scrollable interface allows the client to view a large amount of travel info all from a single screen.

Immediately below the TRAVEL INFO section, there is a section of handpicked activities recommended by the platform. These activities may have been chosen (“tailor made”) based on promotional based criteria and/or to criteria relating to query responses provided by client when completing the first questionnaire.

Immediately below this is a section that allows the client to view all the activities available at a destination which are stored in activity database 20.

In the example Travel Guide, there is also a link that enables a client to view the curators that helped populate the activity database for a given destination. Curators may be given the option to remain unknown.

Disclosing the curators and possibly providing ratings and other detailed information about the curators enhances the trustworthiness of the services provided by the platform, and may also be used by the platform to more optimally select and award curators based on their accuracy (as determined by the clients). A significant value add of the proposed methodology is that activity information is, at least initially, provided predominantly by experts. The experts may, for example, be locals interviewed by professional marketing professionals, and in any case, people providing information who have actually experienced recommended activities and who have no financial interest in the recommendation.

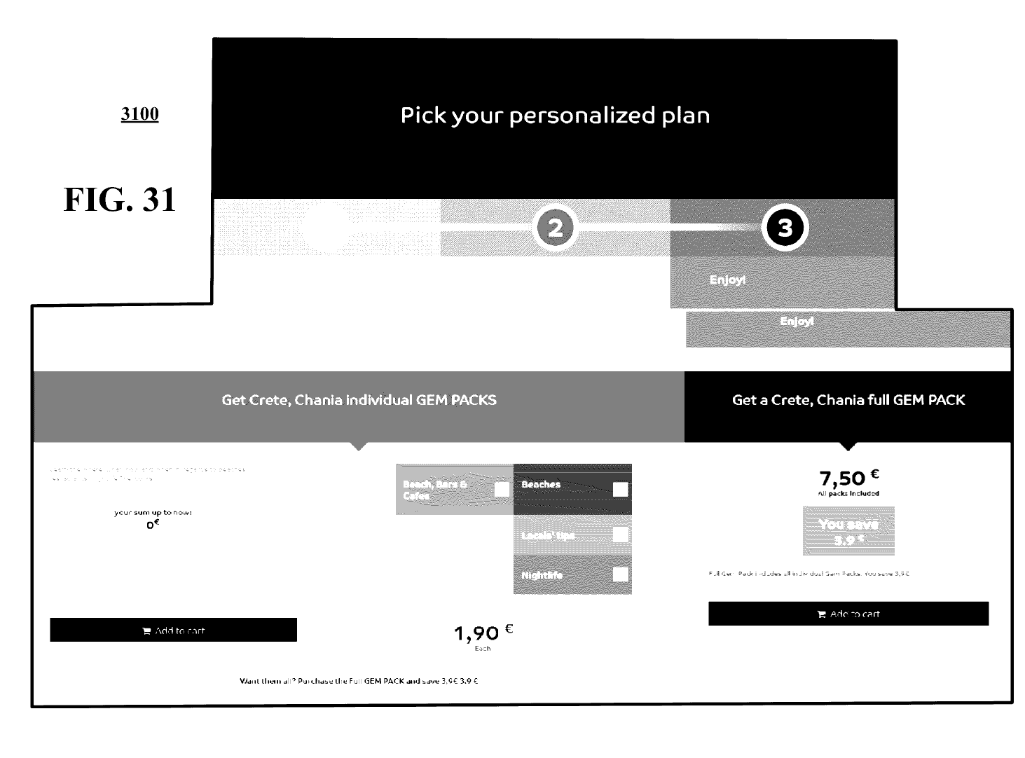

To obtain a gem pack, client clicks on one of the two GET STARTED links in screenshot 2900. From here, the client is taken through a credit card processing process 3100-3300 (FIGS. 31-33) where they are charged according to the type of gem pack they wish to order. For purposes of discussion, we will describe the process and characteristics of obtaining a complete gem pack. The individual gem packs, as has been explained, provide less comprehensive information and are topic focused. A complete gem pack covers all the topics and categories supported by the platform. Travel agents and corporate account holders may be displayed a different page which bypasses payment process.

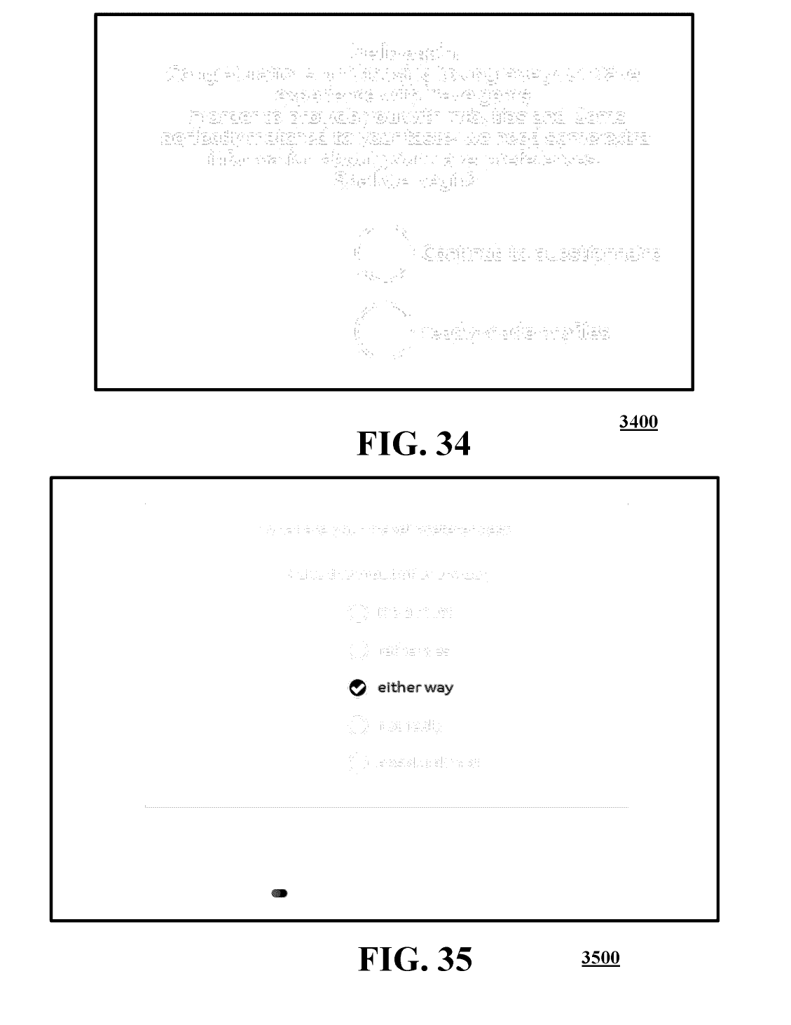

Once payment is complete, client is presented with screenshot 3400 (FIG. 34). Here client is given the option to retrieve ready-made profiles or proceed to the next stage (“continue to questionnaire”). By clicking on “continue to questionnaire”, client is presented with an entirely different set of queries, this time the questions are aimed at the client's specific travel preferences. These travel preferences will in turn be weighted and the search procedure initiated to identify best match activities on a category by category basis.

Screenshots 3500-4700 (FIGS. 35-48) shows some example queries associated with second questionnaire which are employed to identify travel preferences.

Screenshots 4300-4800 employ a user interface provided with multiple scrolling bar selection options to enable a client to make multiple related selections about a topic from a single terminal device display screen (e.g., without scrolling).

In the example screenshots, two different progress bars along different axis of the image are provided in each query page. One is a numerical progress bar indicating across the horizontal axis of image the degree (in terms of percent) that the questionnaire is complete. The other is a pictorial progress bar where “gems” are used in a vertically standing capsule to indicate how full or empty the capsule is, as a way to represent how close the client is to completing the questionnaire.

Once the second questionnaire is complete, the client is presented with a screenshot 4900 (FIG. 49). Here, the client is given the option to have the prepared gem pack displayed or sent to them or a third party, as well as given the opportunity to go back and edit the questionnaire.

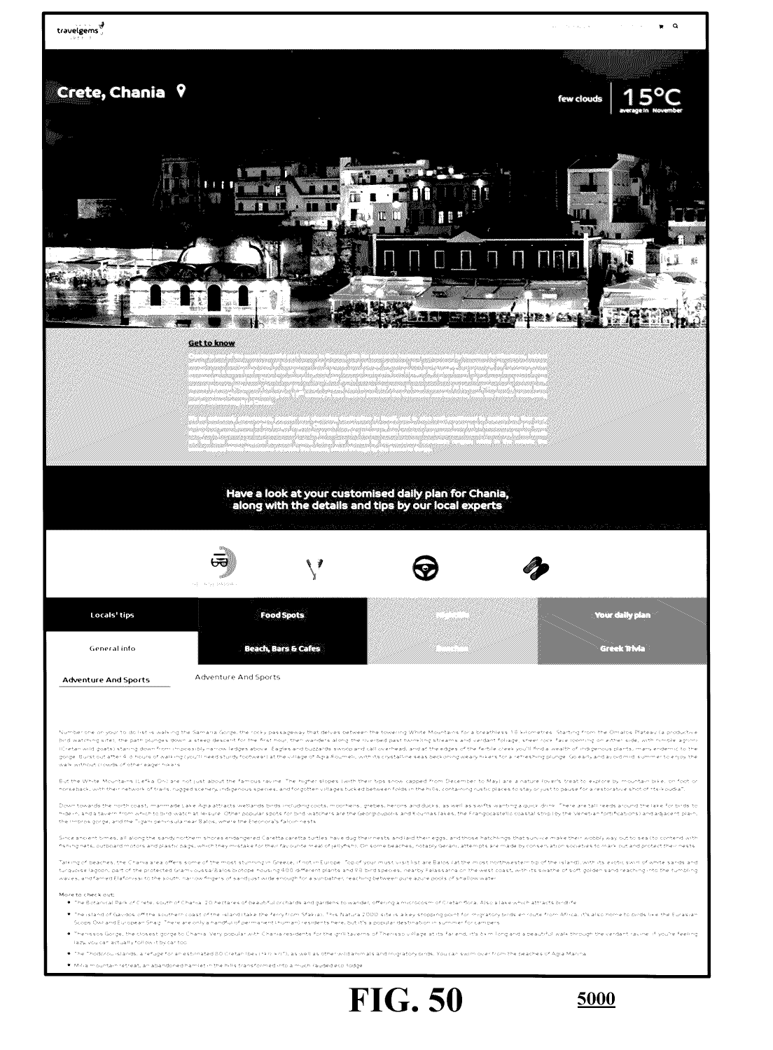

FIGS. 50-56 are web-browser views of partial screenshots 5000-5600 of a newly created gem pack in response to the client destination selection (Crete, Chania) and the answers to the queries in the second questionnaire.

Referring to partial screenshot 5000, here we see an initial set of information provided in the gem pack deliverable produced by the platform. First, next to the city name we find a quick link to a map of the destination. We also find information about current weather information and a link to access more detailed weather information about the destination. The GET TO KNOW section from the TRAVEL GUIDE is again provided. In one scenario, the gem pack GET TO KNOW is more comprehensive and/or customized to describe material of interest to the client based on his profile and profile travel preferences.

Immediately below the GET TO KNOW section, is a section that allows the client to view all the activities available at a destination which are stored in activity database 20, as well as information such as General Info, Local Tips, and local Trivia. As can be seen more clearly in screenshots 5100, 5200, the places activities are displayed in different groups: (i) Beach, Bars & Cafes; (ii) Beaches; (iii) Food Spots and (iv) Nightlife. By scrolling or clicking across the menu, an appropriate dropdown screen section is generated (on the same page) to display information about the activities, which activities have been selected/matched/customized to client's own travel preferences. Activities from these groups are, in turn, used to create the itinerary shown in screenshots 5300 and 5400.

The itinerary is displayed by hovering or clicking on the “YOUR DAILY PLAN” selection of the menu. In the dropdown screen section, a day by day itinerary is shown for each day of travel. To view the gem pack created plan for a given day, client selects the appropriate day from the daily plan. The day's recommended activities are then presented in a further dropdown screen section that opens up in response to this further selection to view the day's activities. In the left margin of this further drop down screen and for each activity is displayed the associated category from which the activity was selected. In one scenario, the client can make selection edits (i.e., remove, add, or replace one activity with another activity in the same category) as desired.

Partial screenshot 5500 are handpicked activities similar to those included in the Travel Guide. Partial screenshot 5600 is a further dropdown screen section that is displayed in response to the client selecting an item from the handpicked activities to explore.

FIG. 57 is a high level operation flow chart illustrating a methodology 5700 of generating a gem pack in accordance with the exemplary embodiment described above.

Access to the Travelgems platform is via web-based access to the www.Travelgems.com URL. A client computing terminal host browser connects to the URL-linked server and uploads the site HOME PAGE (steps 5710, 5720). Here the client has the option is logging on, in which case an initiate log-in procedure is performed, or in the case of a new user, a new client registration routine is initiated (steps 5725, 5730, 5735). Alternatively, the platform identifies that a destination selection has been made and will seek to initiate the process of generating a tailored made Travel Guide for the selected destination (step 5740). The platform confirms again whether or not client is logged-in/registered, and if not invites the client to do so (step 5745).

Once logged-in/registered, the next phase is to initiate the query process associated with a first questionnaire. This process includes checking whether the questionnaire process was previously completed (step 5750). Unless the first questionnaire was previously completed, the client is walked through a series of screens and the selections made by the client processed and recorded as client entries in the Client Profile Database 10 (step 5755).

Upon completion of the first questionnaire, the platform retrieves appropriate search algorithms that will use the recorded profile entries to select best match candidate activities from the set of available activities stored in the activity database 20 for the relevant destination selection (step 5760).

It is to be understood that the use of search algorithms to vet through database records and make best candidate selections is notoriously well known and beyond the scope of this invention. For example, it is common to assigned different weight values to records either individually or in array form, as well as in other combinations, and use such weight values to match one set of inputs to records in a database.

Once the Travel Guide is ready to view, client is notified and display is made possible (step 5765).

In accordance with an exemplary embodiment, TRAVEL GUIDES are free to download and access. A client need only complete the first questionnaire once, and use this same questionnaire to obtain any number of Travel Guides. This is particularly useful if planning to visit multiple locations, island hop, and/or combine business with travel to nearby destinations. Having had the opportunity to learn about different destinations from the various free “TRAVEL GUIDES” provided by the platform, client is in a position to pick from these those destinations for which he would like the platform to select activities that are custom tailored to the client's very specific travel preferences (i.e., order a “gem pack”).

The platform looks for an order request placed by the client for a gem pack and initiates process payment (steps 5770, 5775). As previously explained process payment may be gem pack type dependent, free, discounted or the like depending on the relationship between the client and the platform, whether the client is a travel agent, bulk account holder, or the like, and/or whether the client has promotional access rights entitling them to free or discounted services, as in the case for example as reward for having feedback experience information about experienced activities in compliance with platform rules and conditions.

The proposed Travel Guide and gem pack package combination provides a unique technology solution that brings, for the first time, a complete and automated and extremely personalized concierge experience into an all-in-one online, web-browser friendly solution. By the very nature of how the activity database is created and updated (for example using trusted thirty party input all under the control of the platform administrator), clients are provided with a unique, clever, affordable and travel agent friendly approach to concierge services.

As a next step, to generate the gem pack, the client is presented with a new (second) questionnaire that seeks to identify client's unique travel preferences (step 5780).

As in the case of the Travel Guide, on completion of the second questionnaire, the platform retrieves appropriate search algorithms, generates the gem pack, and informs the client when it is ready to view (step 5785). The client is then able to retrieve and view the gem pack (step 5790). A representative example Travel Guide and gem pack have been illustrated in FIGS. 29, 30 and FIGS. 50-56, respectively.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. In an web-based system, a computer-implemented method to provide automated personalized concierge services, comprising:
identifying a destination selection by a client;
generating and displaying a travel guide for the identified destination in response to client entries to a first questionnaire;
identifying a request to generate a gem pack for the destination selection; and
generating and displaying the gem pack in response to client entries to a second questionnaire,
where the gem pack is comprised of recommendations for each of multiple categories of places and activities, which recommendations are arrived from applying appropriate search algorithms that assign appropriate weights to activities as a function of client entries in the first and second questionnaire,
where the gem pack includes an itinerary for each day of travel to the destination selection for a given set of dates, and
where the gem pack includes at least one gem, where a gem is a place or activity added by the system owner and is not a recommendation by a client to another client.

2. The method of claim 1, wherein the gem pack includes a menu of the categories, whereby clicking on a category opens up a corresponding list of places or activities for that category, at least one of the categories being the itinerary with the itinerary being populated with the places or activities of the categories from which it is comprised.

3. The method of claim 1, wherein the gem pack includes detailed information about the destination selection as well as of each place or activity.

4. The method of claim 1, wherein each category includes menu selections to deselect displayed activities, the method further comprising deselecting places or activities from categories, and automatically repopulating the itinerary to remove deselected places or activities therefrom.

5. The method of claim 1, further comprising automatically rearranging items from the itinerary in response to drag and drop selections by the client.

6. The method of claim 1, further comprising at least one of automatically removing items from the itinerary and automatically replacing removed items with new places or activities from appropriate categories in the gem pack.

7. The method of claim 1, wherein at least one of the travel guide and the gem pack includes a menu including a listing of promotional places or activities associated with the destination selection.

8. The method of claim 1, where at least one of the first and second questionnaires includes a user interface with multiple scrolling bar selection options that enable a client to make multiple related selections about a topic from one screen and without scrolling, and at same time display a progress bar.

9. The method of claim 1, further comprising an option for clients to rate places or activities upon completion.

10. The method of claim 9, further comprising keeping a record of deselections made by clients, and using a self-training algorithm that adjusts the assigned weights to places or activities in response to past deselections to improve future gem pack results.

11. A web-based system for providing automated personalized concierge services, comprising:
means for identifying a destination selection by a client;
means for generating and displaying a travel guide for the identified destination in response to client entries to a first questionnaire;
means for identifying a request to generate a gem pack for the destination selection; and
means for generating and displaying the gem pack in response to client entries to a second questionnaire,
where the gem pack is comprised of recommendations for each of multiple categories of places and activities, which recommendations are arrived from applying appropriate search algorithms that assign appropriate weights to activities as a function of client entries in the first and second questionnaire,
where the gem pack includes an itinerary for each day of travel to the destination selection for a given set of dates, and
where the gem pack includes at least one gem, where a gem is an activity added by the system owner and is not a recommendation by a client to another client.

12. The web-based system of claim 11, wherein the gem pack includes a menu of the categories, whereby clicking on a category opens up a corresponding list of places or activities for that category, at least one of the categories being the itinerary with the itinerary being populated with the places or activities of the categories from which it is comprised.

13. The web-based system of claim 11, wherein the gem pack includes detailed information about the destination selection as well as of each place or activity.

14. The web-based system of claim 11, wherein each category includes menu selections to deselect displayed activities, the system further comprising means for deselecting places or activities from categories, and means for automatically repopulating the itinerary to remove deselected places or activities therefrom.

15. The web-based system of claim 11, further comprising means for automatically rearranging items from the itinerary in response to drag and drop selections by the client.

16. The web-based system of claim 11, further comprising at least one of means for automatically removing items from the itinerary and means for automatically replacing removed items with new places or activities from appropriate categories in the gem pack.

17. The web-based system of claim 11, wherein at least one of the travel guide and the gem pack includes a menu including a listing of promotional places or activities associated with the destination selection.

18. The web-based system of claim 11, where at least one of the first and second questionnaires includes a user interface with multiple scrolling bar selection options that enable a client to make multiple related selections about a topic from one screen and without scrolling, and at same time display a progress bar.

19. The web-based system of claim 11, further comprising an option for clients to rate places or activities upon completion.

20. The web-based system of claim 19, further comprising means for keeping a record of deselections made by clients, and means for using a self-training algorithm that adjusts the assigned weights to places or activities in response to past deselections in order to improve future gem pack results.
